(19) United States
(12) Patent Application Publication
(10) Pub. No.: US 2014/0341477 A1
(43) Pub. Date: Nov. 20, 2014

(54) METHOD AND SYSTEM FOR COMPRESSING A DATA ARRAY WITH PROJECTIONS

(71) Applicants: CERN-European Organization for Nuclear Research, Geneva (CH); Universita Degli Studi Di Padova, Padova (IT)

(72) Inventors: Piero Giubilato, Conegliano (IT); Walter Snoeys, Cernex (FR)

(21) Appl. No.: 14/359,607

(22) PCT Filed: Nov. 22, 2011
(86) PCT No.: PCT/EP2011/005885

§ 371 Date: Aug. 5, 2014

(51) Int. Cl. H04N 5/378; H04N 19/90

(52) U.S. Cl. CPC H04N 5/378; H04N 19/00945
USPC 382/232; 348/302

(57) ABSTRACT

A projective compression scheme for an n-dimensional data array makes use of at least n+1 compression maps in order to maximize the ability to resolve ambiguities. The invention also relates to hardware implementations of the projective compression scheme, and in particular to front end circuits that allow for a compressive readout.

### FIELD OF THE INVENTION

The invention relates to a method and system for compressing data arranged in a data array, in particular for compressing sparsely populated data collected from particle detectors in high-energy physics experiments. The invention further relates to frontend readout circuits for reading out said data arrays.

### Background and State of the Art

Imaging detectors are extensively used in high energy physics, in space sciences, in medical applications, in cameras and in many other fields. Depending on their type they generate images from X-rays, ionizing particles, or visible light. Often they consist of a matrix of sensitive elements (pixels) that are read out by suitable electronics. The sensitive elements can be semiconductor-based, and may, for instance, comprise a diode or a pin-diode. Detection can also be based on a gas in which some ionization occurs due to incoming radiation. In this case, the ionization charge is collected on a wire or on an electrode in the gas, and subsequently read out.

The size of the data representing an image (proportional to the total number of pixels and the amount of information per pixel) is often a concern, and schemes like JPEG have been proposed to compress the image size. Some of these compression schemes are lossless, and allow perfect reconstruction of the original image from the compressed data. In cameras often the full bit-map image is stored and read out to avoid any compression losses, but this comes at the price of high power consumption and increased storage space. Other schemes tolerate some loss to reduce the data size and to minimize the power associated with the processing and storage of the data.

There are many applications in physics and technology where only a very small fraction of the sensitive elements from which the image is composed can be expected to carry a significant signal. For such sparsely populated images, an effective compression mechanism is particularly important, especially when high readout rates are required.

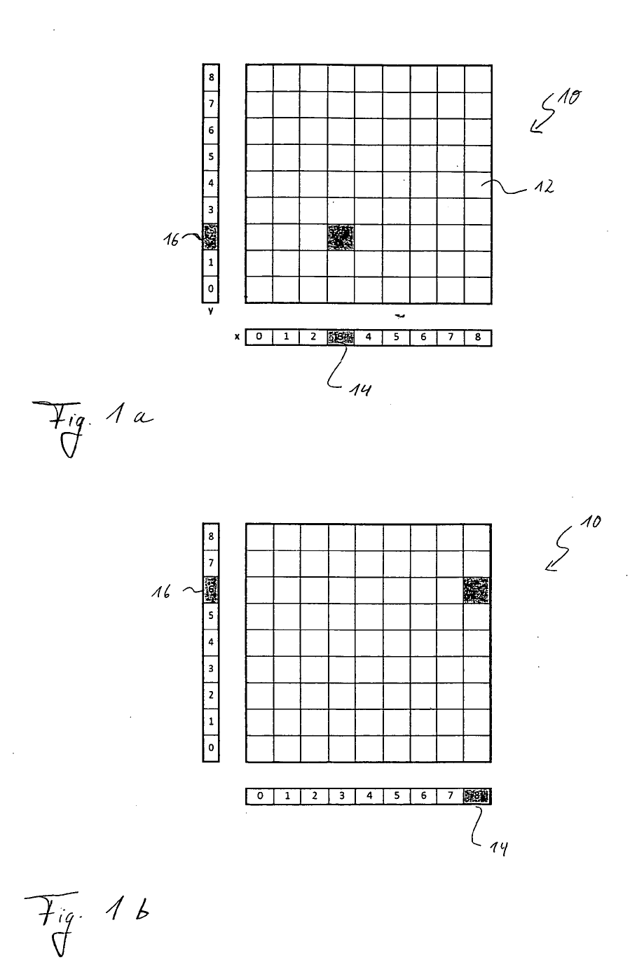

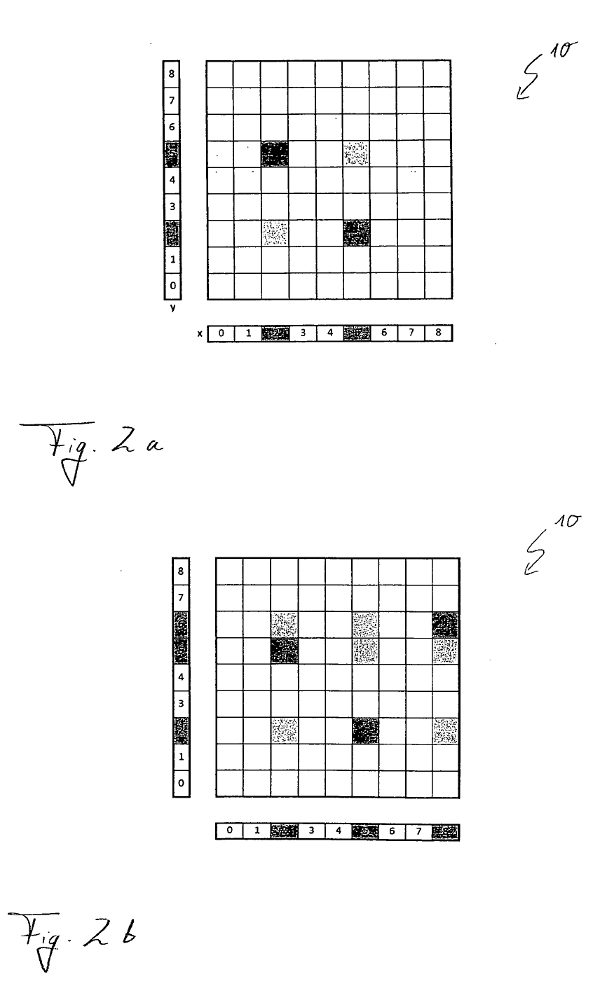

Projection has sometimes been used in the art to reduce the size of the data sample of sparsely populated images. An example of a projection scheme for a square array 10 of 9×9 pixels 12 is illustrated in FIGS. 1a and 1b. Every square corresponds to one pixel 12. Hits are indicated by shaded elements, and are read out by projecting onto the horizontal (x) and the vertical (y) axis. A projection may be implemented by means of readout channels connecting all the pixel elements in a given column or row, respectively, to a collection element or bin element 14, 16 corresponding to that column or row, respectively. In the example described with reference to FIGS. 1a and 1b there are hence 2×9 collection elements, one for each row and column of the 9×9 square matrix. A collection element 14, 16 will indicate a hit if any of the pixels in that particular row or column has been hit. The hit shown in FIG. 1a can be represented by coordinates (3, 2), whereas the hit shown in FIG. 1b has coordinates (8, 6). Projection onto the horizontal and vertical axis reduces the image size from 9² to 2×9. For a general N×N matrix, the image size is reduced by a factor of 2N/N²=2/N.

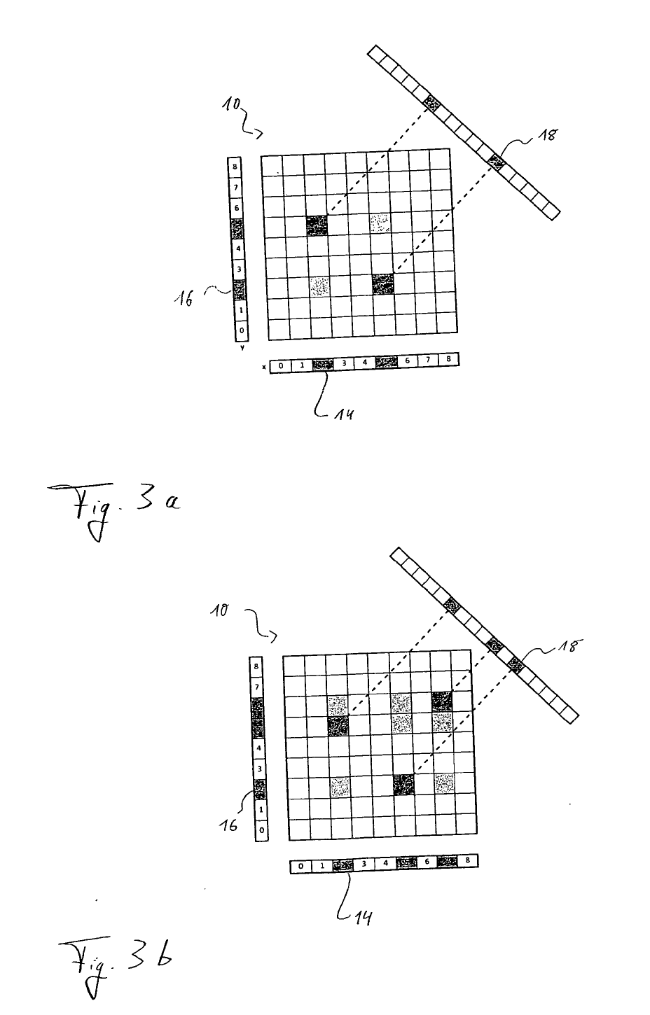

The projection scheme illustrated in FIGS. 1a and 1b is lossless as long as there is only one hit at a time, but ambiguities may arise for multiple hits. This is illustrated in FIG. 2a, in which two real hits are indicated in black. When projected on the horizontal and vertical axes, these two hits will trigger two collection signals on the horizontal axis (x=2 and x=5) and two collection signals on the vertical axis (y=2 and y=5). However, the same collection signals would result in case of four hits, with two additional hits indicated in grey in FIG. 2a. The reduced information resulting from the compression onto the horizontal and vertical axes does not allow distinguishing between these two scenarios.

FIG. 2b illustrates another ambiguous example with three real hits shown in black and six alias or ghost hits shown in grey. As can be taken from FIG. 2b, the number of aliases grows exponentially with the number of hits.

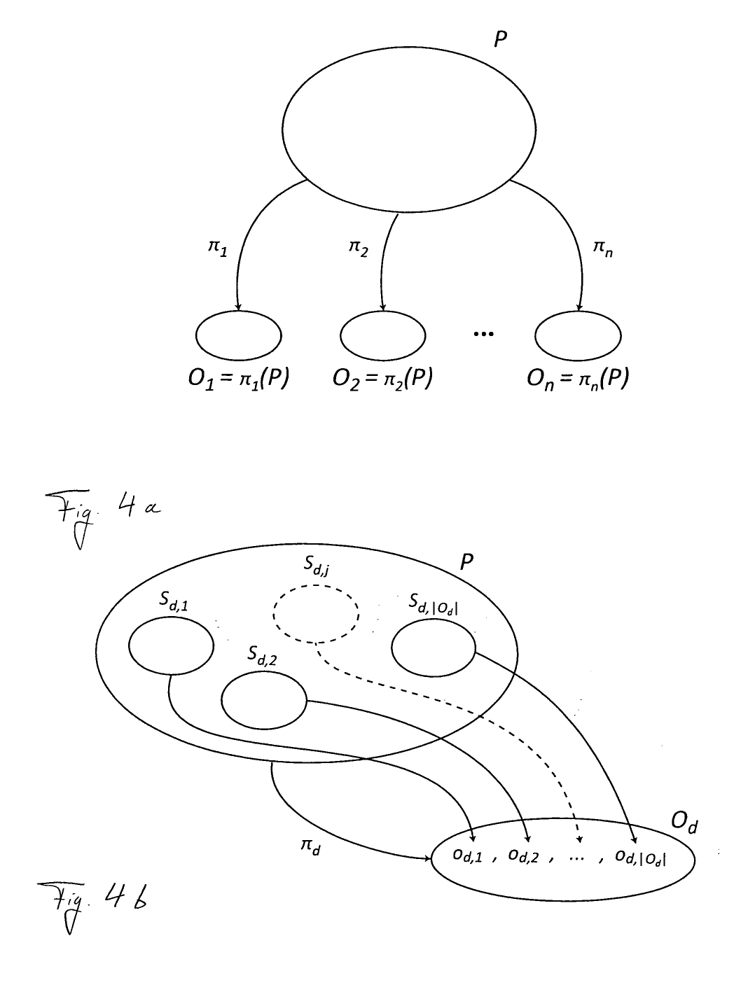

A detector configuration which reduces the ambiguity associated with multiple hits has been proposed by Z. Li in “Novel Silicon Strip Pixel Detector: Concept, Simulation, Design, and Fabrication”, Nuclear Instruments and Methods in Physics Research A 518 (2004), 738-753. Li proposes to make use of an additional set of readout channels arranged at an angle with respect to both the horizontal and vertical readout channels. As shown in FIGS. 3a and 3b, an additional projection onto a diagonal collection element 18 may indeed help to resolve ambiguities associated with multiple hits.

Li's projection scheme has a disadvantage that it resolves ambiguities non-uniformly depending on where they occur on the array. Ambiguities towards the corners of the readout array where only few elements lie on a diagonal are resolved efficiently, whereas the capability of resolving ambiguities towards the center of the array, where the diagonals contain the largest number of elements, is rather poor.

It is an objective of the present invention to provide a readout scheme that reduces ambiguities more efficiently.

Readout frontends for solid state imaging pixel detectors have been designed that are specifically adapted for the readout of sparsely populated images. In these implementations, every pixel typically embeds the electronics necessary to discern the presence of a significant signal, such as a threshold comparator. A tagging mechanism allows the signal to be moved to the periphery only from those pixels carrying any relevant information. The sensor chip sends out the relevant pixel signals and their coordinates for storage and analysis. According to the particular architecture, further information like timestamps or external synchronization triggers can be associated to pixel data to assist in the image reconstruction. Examples of such detectors are described in N. Wermes, “Pixel Detectors for Tracking and Their Spin-off in Imaging Applications”, Nuclear Instruments and Methods in Physics Research A 541 (2005) 150-165.

In all these schemes, the pixel itself decides whether it carries a relevant signal. This greatly reduces the readout time, since only a few pixels instead of the whole matrix array have to be read out at every cycle.

A drawback associated with this approach is the inherent pixel complexity. Every pixel needs to be provided with its own readout circuit, which may involve several hundred transistors. This is a particular challenge when designing detectors with a very large number of small pixels of a few tens of microns or less, which are nowadays required for high-resolution applications.

A further disadvantage is the enhanced power consumption associated with the complex in-pixel readout electronics, since every pixel and the full periphery are continuously active. In many designs, every pixel is clocked, too, and cooling has to be extended to the whole chip surface.

In addition, the output data size is not deterministic in these schemes. It depends on the number of relevant pixels per frame, which may vary from frame to frame. This further enhances the complexity of the readout control logic, which in turn leads to even higher power consumption.

A frontend in which a bipolar transistor is integrated into the detector to directly amplify the detector current was proposed by R. Horisberger, “The Bipolar Silicon Microstrip Detector: a Proposal for a Novel Precision Tracking Device”, Nuclear Instruments and Methods in Physics Research A 288 (1990) 87-91. In this architecture, the detector current is applied to the base of the bipolar transistor, and is then amplified by the current gain factor of the bipolar transistor. Due to the direct amplification on site, the readout complexity is reduced. A further such scheme has been proposed by S. Avrillon et al., “Simulation and First Beam Test of a Single-Sided Two-Dimensional Detector using pMOS Pixels”, Nuclear Instruments and Methods in Physics Research A 386 (1997) 172-176. But these schemes have the drawback that it is not straightforward to integrate additional circuitry with the detecting element and to provide multiple outputs. The current gain in the bipolar transistor as suggested by Horisberger is determined by the process, and hence cannot easily be modified or tuned in a circuit. A bipolar phototransistor may also suffer from a rather limited radiation-tolerance.

It is hence a further objective of this invention to propose an improved frontend that overcomes these drawbacks and allows for an efficient compression when employed in an imaging detector according to the present invention.

### OVERVIEW OF THE PRESENT INVENTION

These objectives are achieved by means of a method and system for compressing a data array of data elements according to independent claims 1 and 14, respectively, as well as by a readout circuit for a data array of data elements according to independent claims 30 and 37, respectively. The dependent claims relate to preferred embodiments.

In a first aspect, the invention relates to a method for compressing a data array of data elements, said data array being arranged in n dimensions for some positive integer n, said method comprising the steps of defining a plurality of at least n+1 compression maps π_{d} on said data array P, 1≦d≦n+1; and associating with each range value o_{d,j} of π_{d} a compression fiber S_{d,j}={pεP|π_{d}(p)=o_{d,j}}; such that, for each compression map π_{d}, said compression fibers S_{d,j} are of at least approximately constant size among all said range values j, |S_{d,j}|=c_{d} for all j, for some constant c_{d}. |•| denotes the set cardinality.

Conventionally, compression has mostly been performed with a number of compression maps that corresponds to the dimensionality of the array. The inventors found that a compression method in which further compression map is added such that all fibers associated with each compression map are of at least approximately constant size allow for a particularly efficient compression, in which a favorable tradeoff can be achieved between the compression rate and the capability of reducing ambiguities. In particular, the inventors found that the method according to the present invention allows resolving ambiguities uniformly over the entire data array.

The data array in the sense of the present invention may be any array of data elements, either a real array such as a pixel matrix or a virtual array in a computer storage in which said data elements may be arranged. It is to be understood that the data array in the sense of the present invention may not correspond to a full matrix of data, but may correspond to a subset of the data. The data array may for instance be an array of sensitive elements in a pixel detector.

Said fibers S_{d,j} may provide a partition of said data array, by collecting those data elements that share a common readout collection or readout channel. The plurality of readout channels π_{d} may correspond to a corresponding plurality of readout collections, and different range values or fibers within said collection may group together those data elements that are collected into a common compression signal or readout signal.

The representation of the invention in terms of compression maps, fibers and constant range values of the compression maps is particularly convenient for characterizing the invention. However, the compression method may not necessarily implement these maps, fibers or range values o_{d,j} in hardware or software. It is sufficient that suitable compression maps, range values and fibers can be associated with the data elements such that the compression can be characterized in this way.

Alternatively, the method according to the present invention may hence be characterized as comprising the step of: providing a plurality of at least n+1 compression collections, wherein each said compression collection comprises a division of said data array P into sub-collections, each sub-collection associated with a common compression value, wherein said sub-collections are representable as compression fibers S_{d,j}={pεP|π_{d}(p)=o_{d,j}} of a plurality of compression maps π_{d}, said plurality of compression maps corresponding to said plurality of compression collections, such that said compression fibers S_{d,j} for each compression maps π_{d} are of at least approximately constant size among all said range values j, |S_{d,j}|=c_{d} for all j, for some constant c_{d}, where |•| denotes the set cardinality.

In the sense of the present invention, compression fibers may be understood to be of “at least approximately constant size among all said range values j” if their relative size difference

$$\frac{‖ {S}_{d , j} \vert - \vert {S}_{d , i} ‖}{max \{ \vert {S}_{d , j} \vert , \vert {S}_{d , i} \vert \}}$$

is less than 20%, preferably less than 10% for all pairs of range values o_{d,j}, o_{d,i}. It is preferred that said compression fibers S_{d,j} are of constant size among all said range values j.

In a preferred embodiment, said compression fibers S_{d,j} are of at least approximately constant size among all said range values j and maps π_{d}, |S_{d,j}|=c for all j,d, for some constant c.

The inventors found that a particularly effective compression can be achieved if the size of the subset of the input data mapped into a single output data element by said compression maps is constant for as many of the data elements and over as many maps as possible.

In particular, a subset of the input data mapped into a single output data element can preferably be mapped into an as large number of output data elements as possible by any other map, preferably in at least as many output elements as the number of elements contained in the input data subset.

Preferably, |πₑ(S_{d,j})|≧|S_{d,j}| holds for almost all compression fibers S_{d,j} and for all pairings of compression maps πₑ, π_{d} such that πₑ≠π_{d}, d,e=1, . . . , n+1.

In a preferred embodiment, the fiber S_{d,j} is mapped into the entire range of the compression map πₑ for almost all compression fibers S_{d,j} and for all pairings of compression maps πₑ, π_{d} such that πₑ≠π_{d} d,e=1, . . . , n+1.

Preferably, the number of compression fibers S_{d,j} is approximately constant for all compression maps π_{d}.

The inventors found that a particularly favorable compression may be achieved if a subset of the input data mapped into a single output data element by a certain map is mapped by any other map into all of its output data elements. This corresponds to the condition that for every map the image of said subset of the input data elements equals the image of the entire input array under this map.

Hence, preferably, |πₑ(S_{d,j})|=|πₑ(P)| holds for almost all compression fibers S_{d,j} and for all pairings of compression maps πₑ, π_{d} such that πₑ≠π_{d}, d,e=1, . . . , n+1.

In a preferred embodiment, said method further comprises the step of associating an output value s_{d,j} with each compression fiber S_{d,j}, said output value being computed from the elements in said compression fiber S_{d,j}.

Said output value s_{d,j} may comprise a binary OR of bit values associated with said data elements in said compression fiber S_{d,j}, or an analogue signal value associated with said data elements, in particular a sum of analogue signal values, wherein each said signal value is associated with a data element in said compression fiber S_{d,j}.

The invention may be employed for data arrays arranged in any dimension. In particular, the invention may be employed for one-dimensional data arrays (n=1), two-dimensional data arrays (n=2), or three-dimensional data arrays (n=3), or any other integer number n=4, n=5, n=6, . . . . Preferably, n≧2 or n≧3.

The number of compression maps exceeds the dimensionality of the data array at least by one. More than the n+1 compression maps may likewise be employed to compress an n dimensional data set, since this may further reduce the ambiguities.

In a preferred embodiment, n=2 and the method comprises the step of defining three compression maps.

Preferably, said data array may be representable as a square array with N by N elements, and π₃ has a range cardinality that divides N.

Preferably, said data array comprises N² data elements representable by an index i, i=1, . . . , N², and

π₁(i)=i mod N,

π₂(i)=└i/N┘, and

π₃(i)=(i+k└i/(kN)┘)mod kN,

wherein, for any real number a, └a┘ denotes the largest integer no larger than a and |π₃(P)|=k×N.

The inventors found that a topological connection between input data elements according to this embodiment is particularly easy and convenient to implement, and still allows a very efficient compression that resolves ambiguities with a constant performance for uniformly distributed input data. This provides an important improvement over the scheme suggested by Li.

Any arbitrary set of L elements can be padded with D dummy elements so that L+D=N². Hence, the previous embodiment can be employed for compression of any two-dimensional data array.

A two-dimensional data array may conveniently be defined in terms of a set of coordinates (x, y). Preferably, π₁≡πₓ is a projection along the columns of said array defined by the equations x=const., with different values of the constant corresponding to different range values o_{1,j}, and wherein π₂≡π_{y} is a projection along the rows of said array defined by the equations y=const., with different values of the constant corresponding to different range values o_{2,j}.

Preferably, said data array is representable as a square array with N×N elements defined in terms of a set (x,y) of coordinates, and wherein

π₃(x,y)=(y mod k)N+((x+└y/k┘k)mod N,

wherein, for any real number a, └a┘ denotes the largest integer no larger than a, and |π₃(P)|=k×N.

In a preferred embodiment, n=2 and the method comprises the step of defining four compression maps.

The inventors found that employing four compression maps in a two-dimensional data array may provide a substantial improvement in the capability of resolving ambiguities.

In a preferred embodiment, said data array (P) comprises N² data elements representable by an index i, i=1, . . . , N², and

π₁(i)=i mod N,

π₂(i)=└i/N┘,

π₃(i)=+└i/N┘)mod N, and

π₄(i)=+└i/N┘(N−1))mod N,

wherein, for any real number a, └a┘ denotes the largest integer no larger than a.

An embodiment employing four compression maps for a two-dimensional data array may likewise be conveniently expressed in terms of a set (x, y) of coordinates. In a preferred embodiment, π₁≡πₓ is a projection along the columns of said array defined by the equations x=const., with different values of the constant corresponding to different range values o_{1,j}, and wherein π₂≡π_{y} is a projection along the rows of said array defined by the equations y=const., with different values of the constant corresponding to different range values o_{2,j}.

Preferably, said data array (P) is an array of N×N elements, and

π₃(x,y)=(x+y)mod N and

π₄(x,y)=(x+y(N−1))mod N.

The invention further relates to a compression system for compressing data arranged in an array (P) of data elements, said data array (P) being arranged in n dimensions for some positive integer n, wherein said system is adapted to implement a plurality of at least n+1 compression maps π_{d} on P, 1≦d≦n+1, and further adapted to associate with each range value o_{d,j} of π_{d} a compression fiber S_{d,j}={pεP|π_{d}(p)=o_{d,j}}, such that said compression fibers S_{d,j} for each compression map π_{d} are of at least approximately constant size among all said range values j, |S_{d,j}|=c_{d} for all j, for some constant c_{d}, where |•| denotes the set cardinality.

The compression system may be adapted to implement a compression method with some or all of the features as described above.

Data elements that belong to a common compression fiber may each be connected among one another, said connection for compressive readout of said data elements.

Said data elements belonging to a common compression fiber may be connected in firmware or in hardware. In particular, said data elements belonging to a common compression fiber may be connected by means of a common readout wire.

In a preferred embodiment, any of said data elements belongs to a number of fibers that corresponds to the number of compression maps.

Said data elements may comprise sensitive elements, in particular, pixel elements.

However, the invention is not so limited and may be employed for any kind of data sets or detector elements. This includes strip detectors with a two-dimensional array of wires. The wires may provide a direct implementation of readout channels, and the intersection of wires may provide a two-dimensional array of sensitive elements.

In a preferred embodiment, the compression system further comprises a readout element with an impedance element, said impedance element having a first terminal adapted for connection to a data element, said impedance element further having a second terminal for connection to a first bias voltage source, wherein said readout element further comprises a first transistor element having a first terminal coupled to said impedance element, a second terminal for connection to a second bias voltage, and a third terminal for connection to a readout channel, said readout channel corresponding to a compression map.

The inventors found that a readout element with these characteristics allows for a projective compression to be carried out early in the readout chain, which reduces the number of signals to be passed on for subsequent signal processing and storage, thereby facilitating power and space savings.

Said second bias voltage may be different from said first bias voltage.

Preferably, said first terminal of said first transistor element is a gate terminal, and/or said second terminal of said first transistor element is a source terminal.

In a preferred embodiment, the readout element comprises at least one further transistor element, wherein each said further transistor element has a respective first terminal coupled to said impedance element and to said first transistor element, and wherein each said further transistor element has a respective second terminal for connection to said second bias voltage source. Preferably, said further transistor elements are identical transistor elements.

In a preferred embodiment, said first transistor element and said further transistor elements each have a third terminal for connection to a respective readout channel, each readout channel corresponding to a compression map.

This allows for a particularly efficient compression, in which a data signal is multiplied into a number of readout channels corresponding to the number of compression maps.

Said impedance element may comprise a transistor, in particular a transistor having a source terminal for connection to said first bias voltage and a gate terminal and/or a drain terminal for connection to said data element.

Alternatively, said impedance element may comprise a diode. Said diode may be adapted for connection to a further diode serving as a data element or detector element, wherein said diodes are connectable with opposing terminals.

In a preferred embodiment, the compression system comprises a readout element with a plurality of diodes, wherein each of said plurality of diodes is adapted to be coupled to a corresponding readout channel, each said readout channel corresponding to a respective compression map.

A readout configuration with a plurality of diodes likewise allows to multiply a readout signal directly into a plurality of readout channels. This may again allow for a particularly efficient compression to be implemented directly in hardware, and hence early in the readout chain.

In a preferred embodiment, said plurality of diodes are adapted to be coupled to a data element, in particular coupled in parallel to a first diode serving as a detector element.

Said plurality of diodes may likewise be formed by providing a respective plurality of diffusion and/or implants in a common substrate. This allows to implement a multiplication of signals directly in the detector element, and may hence reduce the size of the overall compression system.

In a preferred embodiment, the compression system comprises a plurality of readout elements, wherein each readout element is associated with a corresponding data element.

In a preferred embodiment, said compression system comprises a readout element with a first transistor having a source connected to a first voltage source adapted to raise said source to a first bias voltage, said first transistor further having a drain and a gate for connection to said data element.

The readout element may further comprise a second transistor having a source connected to a second voltage source adapted to raise said source to a second bias voltage, and further having a gate coupled to said gate of said first transistor. Preferably, said second bias voltage may be different from said first bias voltage.

In a preferred embodiment, said readout element further comprises a plurality of transistors having a source adapted for connection to said second voltage source, wherein the gates of said plurality of transistors are each connected to the gate of said first transistor.

Said second transistor and said plurality of transistors may each be adapted for coupling to a respective readout channel, each readout channel corresponding to a respective compression map.

In an alternative embodiment, said readout element comprises a diode having a first terminal adapted for connection to a data element and a second terminal for connection to a first bias voltage source. The readout element may further comprise a first transistor having a gate coupled to said diode and a source for connection to a second voltage source adapted to raise said source to a predetermined second bias voltage. Said second bias voltage may be different from said first bias voltage.

The readout element may further comprise a plurality of transistors, wherein the gates of said plurality of transistors are connected to the gate of said first transistor and to said first diode, and wherein the sources of said plurality of transistors are each connected to said second voltage source.

Said second transistor and said plurality of transistors may each be adapted for coupling to a respective readout channel, each readout channel corresponding to a respective compression map.

The invention further relates to a readout circuit for a data array of data elements, said readout circuit comprising an impedance element, said impedance element having a first terminal adapted for connection to a data element, as well as a second terminal for connection to a first bias voltage source. Said readout circuit further comprises a first transistor element having a first terminal coupled to said impedance element, and a second terminal for connection to a second bias voltage source, wherein said second bias voltage is different from said first bias voltage.

The inventors found that this readout circuit is perfectly suited for a fast projective readout. Advantageously, the readout circuit according to the present invention allows the projective compression to be carried out directly in the readout circuit, i.e. on the digital or analog signals provided by the data elements. The invention hence allows an implementation of the compression early in the readout chain, which reduces the number of signals to be passed on for subsequent signal processing and storage.

In a preferred embodiment, said first terminal of said first transistor element is a gate terminal, and/or said second terminal of said first transistor element is a source terminal.

Preferably, the readout circuit comprises at least one further transistor element, wherein each said further transistor element has a respective first terminal coupled to said impedance element and to said first transistor element, and wherein said further transistor element has a respective second terminal for connection to said second bias voltage source.

A configuration employing further transistor elements allows multiplying a detector signal directly into a corresponding number of readout channels, thereby facilitating the readout. Preferably, said further transistor elements are identical transistor elements.

In a preferred embodiment, said first transistor element and said further transistor elements each have a third terminal for connection to a respective readout channel.

Preferably, said impedance element comprises a transistor, in particular a transistor having a source terminal for connection to said first bias voltage and a gate terminal and/or drain terminal for connection to said data element.

Said impedance element may comprise a diode.

In a preferred embodiment, said data element comprises a detector diode, wherein said diode is adapted to be coupled to said detector diode. Preferably, said diode and said detector diode are coupled with opposing terminals.

The invention further relates to a readout circuit for a data array of data elements, said readout circuit comprising a plurality of circuit elements, in particular a plurality of identical circuit elements, said circuits elements associated with a common data element, wherein each of said plurality of circuit elements is adapted to be coupled to a corresponding readout channel.

In a preferred embodiment, said circuit elements are passive elements, i.e. elements that do not provide a signal amplification. Preferably, said readout circuit does not comprise amplification elements for amplifying signals provided by said common data element.

In a particularly preferred embodiments, said circuit elements are diodes, in particular a plurality of identical diodes.

As described above, a plurality of diodes allows to multiply the signals provided by the data element into a corresponding plurality of readout channels, even without amplification.

In a preferred embodiment, said diodes are adapted to be coupled in parallel to said common data element.

Alternatively, said plurality of diodes may be formed by providing a respective plurality of diffusions and/or implants in a common substrate, in particular in a common substrate of a data element.

In a further aspect, the invention relates to a method for reading out an array of sensitive elements, said array being at least two-dimensional and being represented by a pair of coordinates (x,y), wherein the method comprises the steps of dividing said sensitive elements into a plurality of M sets, wherein said M sets are of at least approximately equal size, and collecting readout signals in a plurality of M collections, wherein a readout signal from a sensitive element in the m^{th} set triggers a readout signal in the m^{th} collection, for m=1, . . . M. Said plurality of M collections is representable by a map π:(x,y)→π(x,y), wherein the set of sensitive elements in the m^{th} set satisfy π(x,y)=m for m=1, . . . , M, and wherein π(x₁,y)≠π(x₂,y) for almost all x₁≠x₂ and for almost all y, and π(x,y₁)≠π(x,y₂) for almost all y₁≠y₂ and for almost all x.

The inventors found that a readout method in which the above inequalities hold allows for a particularly efficient readout, in which a favorable tradeoff can be achieved between the compression rate and the capability of reducing ambiguities. In particular, the inventors found that the division of the sensitive elements according to the invention allows to resolves ambiguities uniformly over the entire array.

It is to be understood that an array of sensitive elements according to the present invention may not correspond to a full matrix of pixels in a given pixel detector or a full array of readout pads or readout wires, but may correspond to a subset of pixels or readout pads/wires.

In the sense of the present invention, a relation that holds “for almost all” elements x and/or y shall be understood to encompass that the relation holds for all such elements x and y. In general, a relation that holds for “almost all” elements x,y shall be understood to hold for at least 80% of all such elements in said array, and preferably for at least 90% of said sensitive elements in said array. It is particularly preferable that these relations hold for all said sensitive elements.

Similarly, in the sense of the present invention sets of “at least approximately equal size” may be of equal size or of approximately equal size. Two such sets A₁, A₂ can be understood to be approximately equal in size if their relative size difference

$$\frac{‖ {A}_{1} \vert - \vert {A}_{2} ‖}{max \{ \vert {A}_{1} \vert , \vert {A}_{2} \vert \}}$$

is less than 20%, preferably less than 10%. It is preferred that their sizes are equal.

For a readout collection to be representable by a map π with the above features, it is not necessary (though it is possible) that this map π is actually implemented in the readout circuitry, be it in hardware or firmware or software. It is sufficient that the readout signals from the sensitive elements are collected in a way that allows them to be mathematically represented or described in this way.

It shall be further understood that the division of sensitive elements according to the present invention may not necessarily be the only division of sensitive elements in a given detector array. It may rather be an additional subdivision such as to complement and enhance a conventional two-dimensional projection scheme onto horizontal and vertical axes, as described above with reference to FIGS. 1 and 2. In this instance, the readout method further comprises the steps of dividing said sensitive elements into a second plurality of sets and collecting readout signals from said second plurality of sets in a second plurality of collections, as well as dividing said sensitive elements into a third plurality of sets and collecting readout signals in a third plurality of collections. Said second and third plurality of sets may all be of approximately equal size. The second plurality of sets may correspond to the columns of an array of sensitive elements, and collecting readout signals from the second plurality of collections may correspond to projection onto the horizontal axis. The third plurality of sets may correspond to the rows of the array of sensitive elements, and collecting readout signals in said third collection may correspond to projection onto the vertical axis.

In a preferred embodiment x=1, . . . , N, y=1, . . . , N, and M=k×N for some positive integer k.

Preferably, π(x,y)=(y mod k)N+((x+└y/k┘k)mod N, wherein, for any real number a, └a┘ denotes the largest integer no larger than a. Preferably, k=1.

The inventors found that a subdivision of sensitive elements according to this embodiment is particularly easy and convenient to implement, and still allows a very efficient compression that resolves ambiguities in the conventional horizontal and vertical projection in a uniform way.

In a preferred embodiment, x=1, . . . , Nₓ, y=1, . . . , N_{y}, and M<NₓN_{y}.

In a further aspect, the present invention relates to a method for reading out an array of sensitive elements, said array being at least two-dimensional, wherein said method comprises the steps of representing each sensitive element in said array by a first pair of coordinates (x,y), wherein x=1, . . . , Nₓ and y=1, . . . , N_{y} for positive integers Nₓ and N_{y}, and by a second pair of coordinates (u,v), wherein u=1, . . . , Nᵤ and v=1, . . . , Nᵥ for positive integers Nᵤ and Nᵥ; collecting readout signals in a first plurality of collections, wherein each collection among said first plurality of collections collects readout signals from a set of sensitive elements for which y=const.; collecting readout signals in a second plurality of collections, wherein each collection among said second plurality of collections collects readout signals from a set of sensitive elements for which x=const.; collecting readout signals in a third plurality of collections, wherein each collection among said third plurality of collections collects readout signals from a set of sensitive elements for which v=const.; and collecting readout signals in a fourth plurality of collections, wherein each collection among said fourth plurality of collections collects readout signals from a set of sensitive elements for which u=const.; wherein said second pair of coordinates (u,v) is connected to said first pair of coordinates (x,y) by means of a bijective transformation τ:(x,y)→τ(x,y)=(τᵤ(x,y), τᵥ(x,y))=(u,v) that satisfies the constraints,

|τᵤ(•,y)|=Nᵤ=Nₓ for almost all y=1, . . . ,N_{y},

|τᵤ(x,•)|=Nᵤ for almost all x=1, . . . ,Nₓ,

|τᵥ(x,•)|=Nᵥ=N_{y} for almost all x=1, . . . ,Nₓ, and

|τᵥ(•,y)|=Nᵥ for almost all y=1, . . . ,N_{y},wherein |•| denotes the cardinality of the range set.

The inventors found that a readout method in which readout signals are collected in four different pluralities of collections, corresponding to the coordinate lines of two different coordinate systems (x,y) and (u,v), respectively, likewise allows to provide a more efficient projective readout system in which ambiguities may be resolved with enhanced probability, and hence provides an alternative solution to the problem underlying the present invention.

Again, a relation that holds “for almost all” elements x,y, shall be understood to encompass also the case where said relation holds for all these elements. In fact, it is preferred that the above relations hold for all elements x and y, respectively.

In the sense of the present invention, a relation that holds for almost all elements x, y can in general be understood to hold for at least 80% of said elements x, y, and preferably for at least 90% of all elements x, y.

In a preferred embodiment, Nₓ=N_{y}=Nᵤ=Nᵥ.

Different collections in the first plurality of collections may be distinguished by different (constant) values of y. For instance, the constant y may label different columns in a two-dimensional array of sensitive elements. Similarly, different collections in the second, third and fourth plurality of collections may be distinguished by different values of x, v, and u, respectively.

Preferably, the coordinate lines x=const. are orthogonal to the coordinate lines y=const. In this instance, the first pair of coordinates (x, y) corresponds to a conventional projective readout onto the horizontal and vertical axes of the array of sensitive elements.

In a preferred embodiment, Nₓ=N_{y} and τᵤ(x,y)=(x+y)mod Nₓ and τᵥ(x,y)=(x+y(Nₓ−1))mod Nₓ.

The invention also relates to an imaging detector comprising an array of sensitive elements, said array being at least two-dimensional and being represented by coordinates (x,y), as well as a plurality of M readout channels, wherein each readout channel connects a plurality of sensitive elements, said plurality of readout channels being representable by map π: (x,y)→π(x,y), wherein the set of sensitive elements that are connected by the m^{th} readout channel are the set of sensitive elements (x,y) such that π(x,y)=m for m=1, . . . , M. The readout channels are configured such that the number of sensitive elements connected by a common readout channel is at least approximately constant, and wherein π(x₁,y)≠π(x₂,y) for almost all x₁≠x₂ for almost all y and π(x,y₁)≠π(x,y₂) for almost all y₁≠y₂ for almost all x.

In a preferred embodiment, x=1, . . . , N, y=1, . . . , N, and M=k N for some positive integer k.

Preferably, π(x,y)=(y mod k)N+((x+└y/k┘k)mod N, wherein, for any real number a, └a┘ denotes the largest integer no larger than a.

In a preferred embodiment, said array is a rectangular array, in particular a square array, wherein the x-coordinate denotes the column and the y-coordinate denotes the row of said array, or conversely.

A rectangular or square array in the sense of the present invention may refer to the physical shape of the array, but may likewise refer merely to the topological connection of the sensitive elements. The physical array shape may actually differ from the rectangular or square configuration, as long as the array can be mathematically or topologically represented in this shape. The sensitive elements can be of any shape.

In a preferred embodiment, the imaging detector may comprise a second plurality of readout channels, wherein each readout channel among said second plurality of readout channels connects a second plurality of said sensitive elements for which y=constant. Different values of the constant may correspond to different readout channels in the second plurality of readout channels. The imaging detector may further comprise a third plurality of readout channels, wherein each readout channel among said third plurality of readout channels connects a third plurality of said sensitive elements for which x=constant. Different values of x may correspond to different readout channels in the third plurality of readout channels.

Each sensitive element in said array may be connected to one readout channel among said first plurality of readout channels and one readout channel among said second plurality of readout channels and one readout channel among said third plurality of readout channels, so that each sensitive element may be connected to three different readout channels in total.

However, the invention is not so limited, and may comprise further readout channels beyond the first, second, and third plurality of readout channels.

It is also to be understood that said readout channels may not necessarily be implemented as hard-wired connections, but may likewise be implemented in firmware or software.

In a further aspect, the invention relates to an imagining detector comprising an array of sensitive elements, said array being at least two-dimensional, as well as a first plurality of readout channels, wherein each readout channel among said first plurality of readout channels connects a first plurality of said sensitive elements, a second plurality of readout channels, wherein each readout channel among said second plurality of readout channel connects a second plurality of said sensitive elements, and a third plurality of readout channels, wherein each readout channel among said third plurality of readout channels connects a third plurality of said sensitive elements. According to this aspect, the number of sensitive elements in each said first, second and third plurality of sensitive elements is at least approximately constant among all readout channels in said first, second and third plurality of readout channels, respectively.

The readout channels in the first, second and third plurality of readout channels may generally differ, but are not necessarily disjunct. Hence, a sensitive element may in general be connected to more than one readout channel, and may preferably be connected to one readout channel from the first plurality of readout channels, one readout channel from the second plurality of readout channels, and one readout channel from the third plurality of readout channels.

The inventors found that an imaging detector in which the number of sensitive elements in each said first, second and third plurality of sensitive elements is at least approximately constant allows to enhance the uniformity with which ambiguities may be resolved. The number of sensitive elements in any or each of said first plurality of sensitive elements may differ from the number of sensitive elements in any or each of said second plurality of sensitive elements, which in turn may differ from the number of sensitive elements in any or each of the third plurality of sensitive elements, as long as the number of sensitive elements among the first plurality of sensitive elements is at least approximately constant, the number of sensitive elements among the second plurality of sensitive elements is at least approximately constant, and the number of sensitive elements among the third plurality of sensitive elements is at least approximately constant.

As before, the number of sensitive elements may be considered “approximately constant” if it varies by less than 20%, preferably by less than 10% with respect to the total number of elements in the respective plurality of sensitive elements. Preferably, the number of sensitive elements in each said first plurality of sensitive elements is constant and/or the number of sensitive elements in each said second plurality of sensitive elements is constant and/or the number of sensitive elements in each said third plurality of sensitive elements is constant. The constants may differ among the first, second and third plurality of sensitive elements.

In a preferred embodiment, almost any two sensitive elements that are connected by a readout channel among said third plurality of readout channels share neither a common first readout channel nor a common second readout channel.

The formulation “almost any” two sensitive elements shall be understood to mean that the number of pairs of sensitive elements that share a common first readout channel and/or a second common readout channel is less than 20% of all pairs, preferably less than 10% of all pairs. Preferably, any two sensitive elements that are connected by a readout channel among said third plurality of readout channels share neither a common first readout channel nor a common second readout channel.

In a preferred embodiment, each sensitive element in said array is connected to a first readout channel from said first plurality of readout channels and to a second readout channel from said second plurality of readout channels and to a third readout channel from said third plurality of readout channels.

Preferably, the first plurality of readout channels are parallel among one another, and are orthogonal to the second plurality of readout channels. Preferably, the second plurality of readout channels are likewise parallel among one another.

In a preferred embodiment, said array is a rectangular array, in particular a square array, wherein said first readout channels are arranged along the columns of said array and said second readout channels are arranged along the rows of said array.

Said third readout channels may be arranged along directions that are in general diagonal to said first readout channels and/or said second readout channels.

In a preferred embodiment, said first readout channels are arranged along the columns of said array and said second readout channels are arranged along the rows of said array, and each of said third readout channels is arranged along a diagonal or a plurality of diagonals of said array, wherein said diagonal/diagonals are chosen such that the total number of their sensitive elements is at least approximately constant.

In this configuration, the ambiguities associated with multiple hits may be resolved uniformly across the entire readout array. This provides an important improvement over the scheme suggested by Z. Li.

Preferably, said diagonals corresponding to different readout channels are parallel diagonals.

Said array may be a square array, and the diagonals may be at most two diagonals of said square array, wherein the first diagonal and the second diagonal are chosen such that the total number of sensitive elements in said first diagonal and said second diagonal equals the number of rows or columns in said square array.

The inventors found that an imaging detector comprising three pluralities of readout channels provides a good tradeoff between the achievable compression rate and the capability of resolving ambiguities associated with multiple hits. However, the invention is not so limited, and may comprise further pluralities of readout channels so to further reduce the number of ambiguities.

In a preferred embodiment, the detector comprises a fourth plurality of readout channels, wherein each readout channel among said fourth plurality of readout channels connects a fourth plurality of said sensitive elements, and wherein the number of sensitive elements in each said fourth plurality of sensitive elements is at least approximately constant among all readout channels in said fourth plurality of readout channels.

In a preferred embodiment, the number of sensitive elements in each said fourth plurality of sensitive elements is constant among all readout channels in said fourth plurality of readout channels.

In a preferred embodiment, almost any two sensitive elements that are connected by a readout channel among said fourth plurality of readout channels share neither a common first readout channel nor a common second readout channel nor a common third readout channel.

The formulations “approximately constant” and “almost any” are to be understood in the sense as described above.

In a preferred embodiment, any two sensitive elements that are connected by a readout channel among said fourth plurality of readout channels share neither a common first readout channel nor a common second readout channel nor a common third readout channel.

Said fourth readout channels may be arranged along directions that are in general diagonal to said first readout channels and/or said second readout channels.

In a preferred embodiment, said first readout channels are arranged along the columns of said array and said second readout channels are arranged along the rows of said array, and each of said fourth readout channels are arranged along a diagonal or a plurality of diagonals of said array, wherein the diagonals are chosen such that the total number of their sensitive elements is at least approximately constant.

The diagonals corresponding to different readout channels may be parallel diagonals.

In a preferred embodiment, said diagonals of said fourth readout channels may in general be orthogonal to said diagonals of said third readout channels.

The invention further relates to an imaging detector comprising an array of sensitive elements, said array being at least two-dimensional, wherein each sensitive element in said array is represented by a first pair of coordinates (x,y), wherein x=1, . . . , Nₓ and y=1, . . . , N_{y} for positive integers Nₓ and N_{y}, and wherein each sensitive element in said array is further represented by a second pair of coordinates (u,v), wherein u=1, . . . , Nᵤ and v=1, . . . , Nᵥ for positive integers Nᵤ and Nᵥ. The imaging detector comprises a first plurality of readout channels, wherein each readout channel among said first plurality of readout channels connects a first plurality of sensitive elements for which y=constant. The imaging detector further comprises a second plurality of readout channels, wherein each readout channel among said second plurality of readout channels connects a second plurality of said sensitive elements for which x=constant. The imaging detector further comprises a third plurality of readout channels, wherein each readout channel among said third plurality of readout channels connects a third plurality of said sensitive elements for which v=constant, and a fourth plurality of readout channels, wherein each readout channel among said fourth plurality of readout channels connects a fourth plurality of said sensitive elements for which u=constant. The first, second, third and fourth plurality of readout channels are configured such that a bijective transformation τ:(x,y)→Σ(x,y)=(τᵤ(x,y), τᵥ(x,y))=(u,v) that transforms the first pair of coordinates (x,y) into the second pair of coordinates (u,v) satisfies the constraints,

|τᵤ(•,y)|=Nᵤ=Nₓ for almost all y=1, . . . ,N_{y},

|τᵤ(x,•)|=Nᵤ for almost all x=1, . . . ,Nₓ,

|τᵥ(x,•)|=Nᵥ=N_{y} for almost all x=1, . . . ,Nₓ, and

|τᵥ(•,y)|=Nᵥ for almost all y=1, . . . ,N_{y}, wherein |•| denotes the cardinality of the range set.

In a preferred embodiment, Nₓ=N_{y}=Nᵤ=Nᵥ.

Preferably, the readout channels of the first plurality of readout channels are parallel among one another and are orthogonal to the readout channels of the second plurality of readout channels. The second plurality of readout channels may likewise be parallel among one another.

In a preferred embodiment, the third plurality of readout channels are arranged along directions that are in general diagonal with respect to said first plurality of readout channels and/or said second plurality of readout channels.

Preferably, Nₓ=N_{y} and τᵤ(x,y)=(x+y) mod Nₓ and τᵥ(x,y)=(x+y(Nₓ−1))mod Nₓ.

In a preferred embodiment, said array is a pixel array, and said sensitive element is a pixel element.

However, the invention is not so limited, and may be employed for any detector with a two-dimensional detector configuration. This includes strip detectors with a two-dimensional array of wires. The wires may provide a direct implementation of readout channels, and the intersection of wires may provide a two-dimensional array of sensitive elements.

### DETAILED DESCRIPTION OF PREFERRED EMBODIMENTS

The features and numerous advantages of the present invention will become apparent from a detailed description of the accompanying drawings, in which:

FIGS. 1a and 1b illustrate the principle of a projective readout according to the state of the art, in which hits are projected on a horizontal (x) and on a vertical (y) axis;

FIGS. 2a and 2b illustrate how the x, y-projection illustrated in FIGS. 1a and 1b gives rise to ambiguities in case of multiple hits;

FIGS. 3a and 3b illustrate how an additional diagonal projection helps to resolve the ambiguities resulting from multiple hits for the specific examples illustrated in FIGS. 2a and 2b;

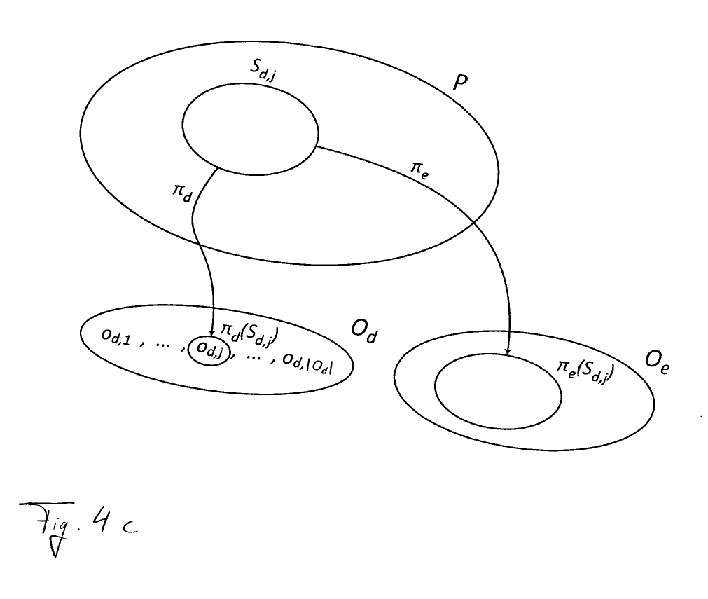

FIG. 4a illustrates the use of static maps to reduce the number of elements of a set P from |P| to the sum of the sizes of the different maps output images;

FIG. 4b illustrates the condition of each map providing a partition of the original set P, and highlights how every output defines, through the map inverse, a subset of the original input set;

FIG. 4c illustrates the “local orthogonality” condition: for every possible subset defined by a particular map and one of its output values, all the other maps have to map this subset into an output set at least of the same size;

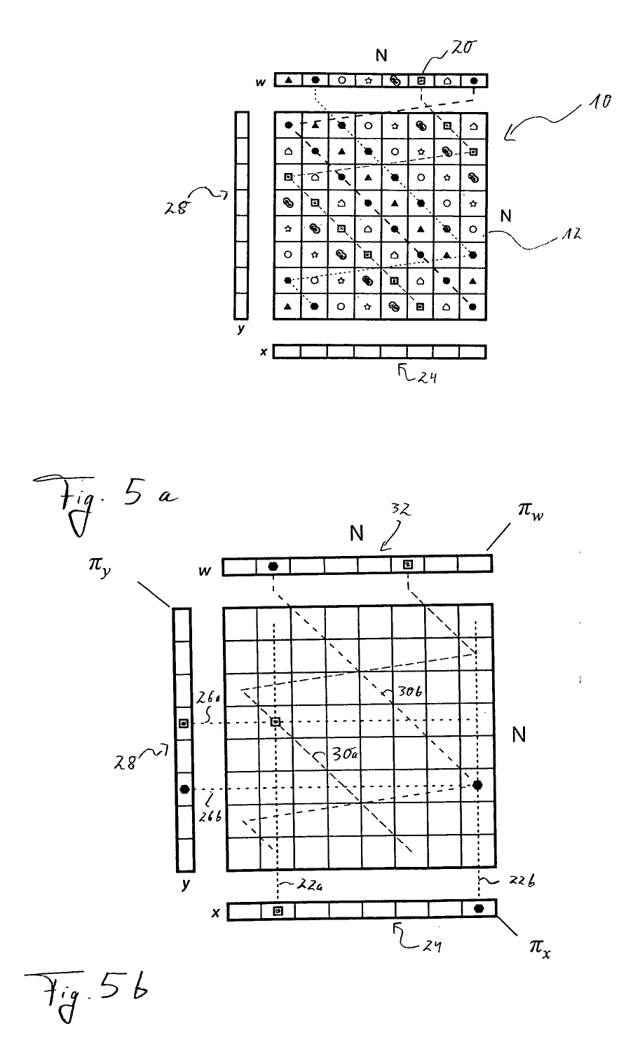

FIG. 5a illustrates the implementation of a third projection mapping according to an embodiment of the present invention;

FIG. 5b illustrates the wiring scheme for the embodiment illustrated in FIG. 4a;

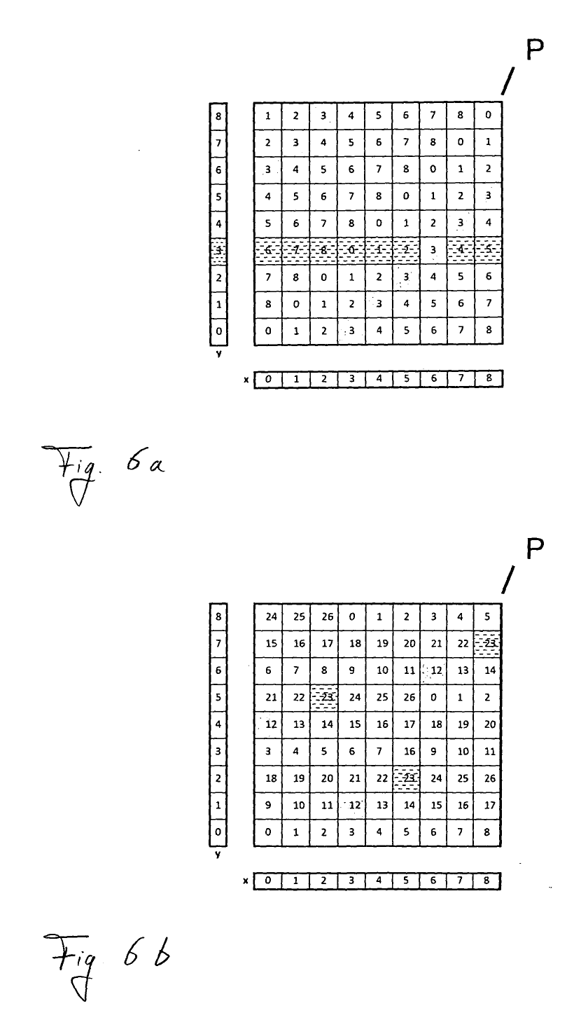

FIGS. 6a and 6b illustrate alternative implementations of a third projection mapping according to an embodiment of the present invention;

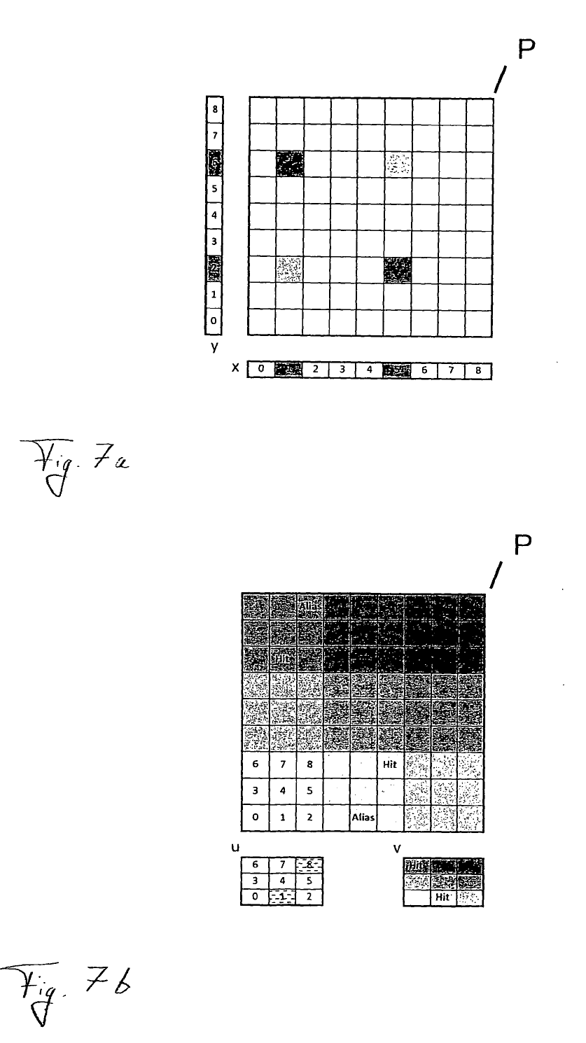

FIGS. 7a and 7b illustrate how ambiguities resulting from multiple hits may be further reduced by employing two different sets of coordinates, in accordance with another embodiment of the present invention;

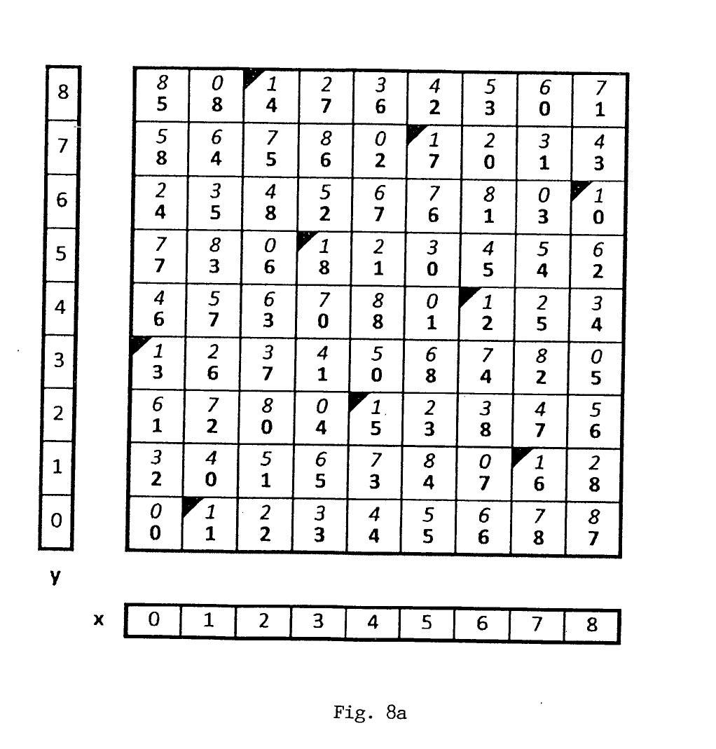

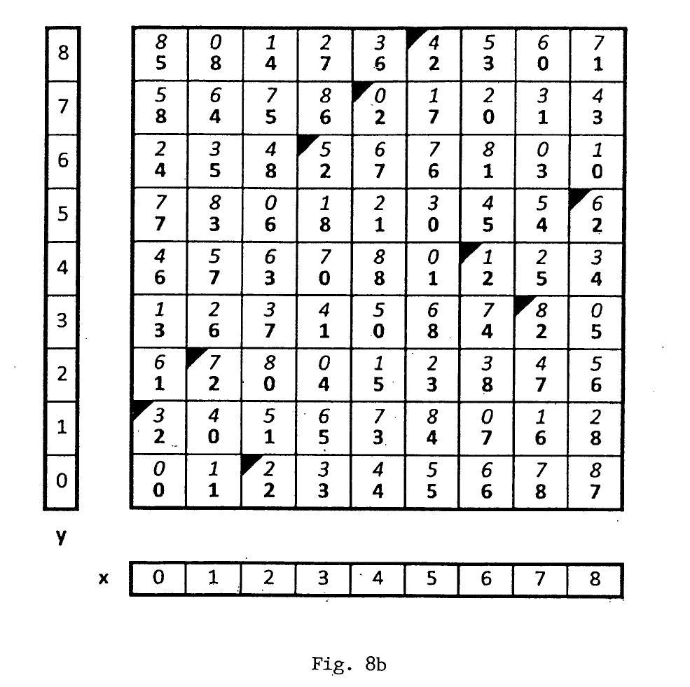

FIGS. 8a and 8b illustrate an implementation of a projection mapping with two sets of coordinates according to an embodiment of the present invention;

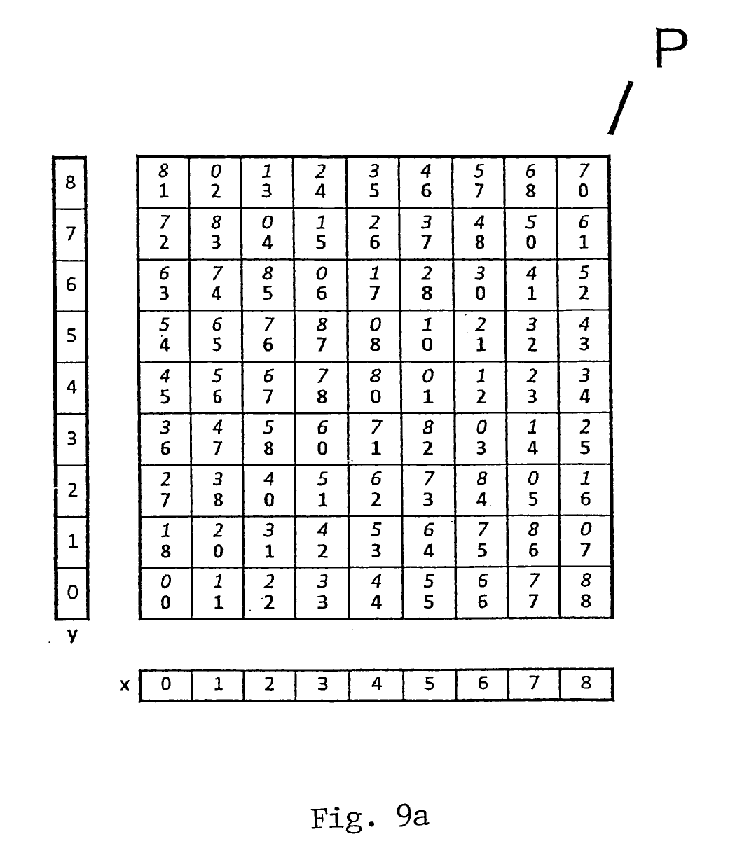

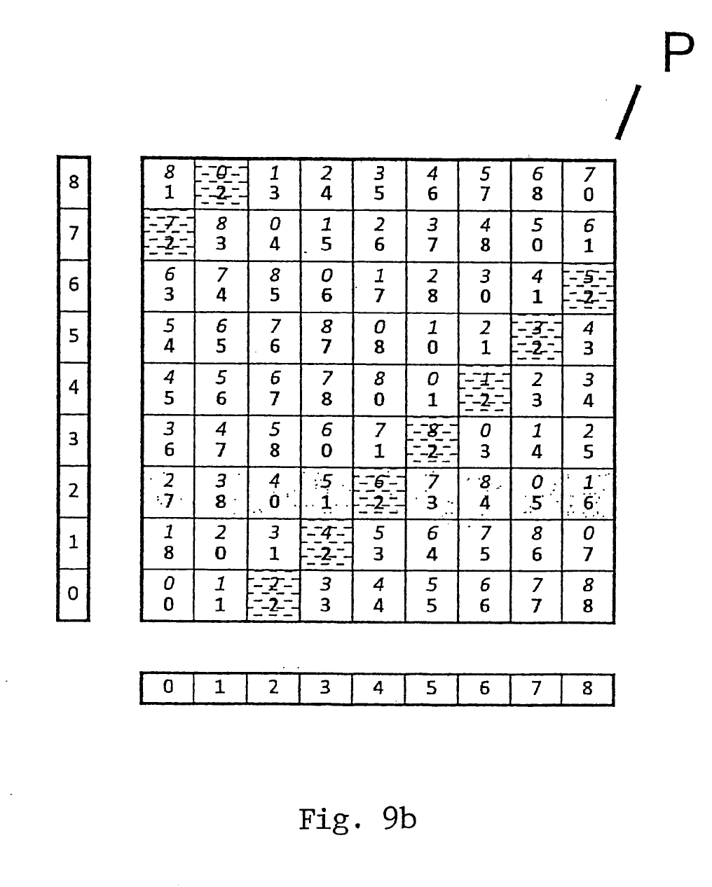

FIGS. 9a and 9b illustrate a further projection mapping with two sets of coordinates according to an embodiment of the present invention;

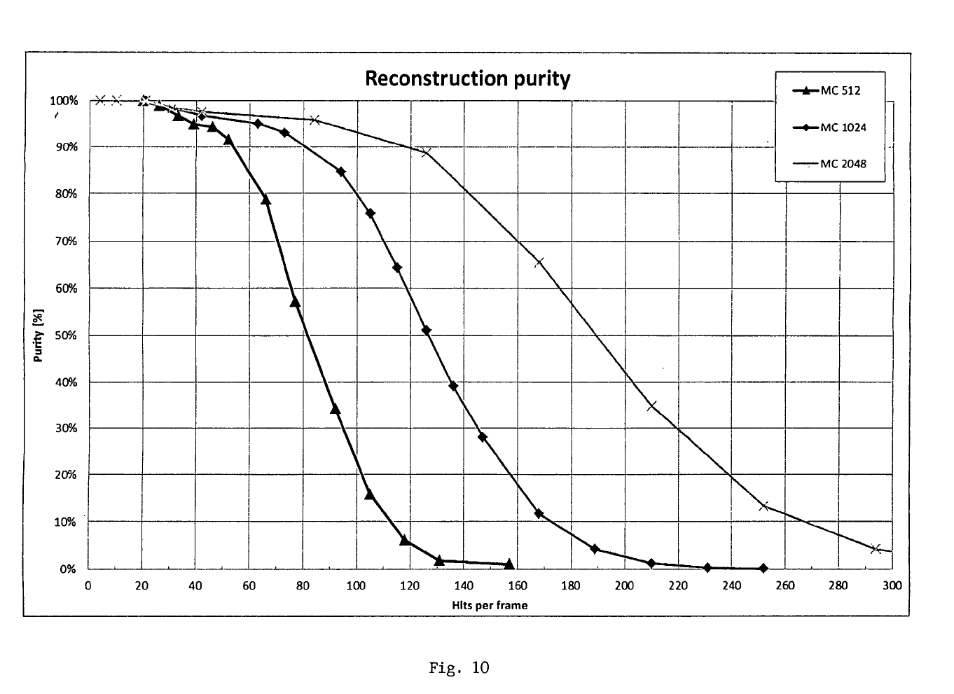

FIG. 10 shows how a projection mapping according to the present invention allows resolving ambiguities, as a function of the number of hits per frame;

FIG. 11 schematically shows a conventional readout circuit comprising an amplifier-shaper and a comparator;

FIG. 12 shows a readout circuit according to the present invention that is equipped with three NMOS transistors to drive three different output lines, each one corresponding to one projective map of the compression;

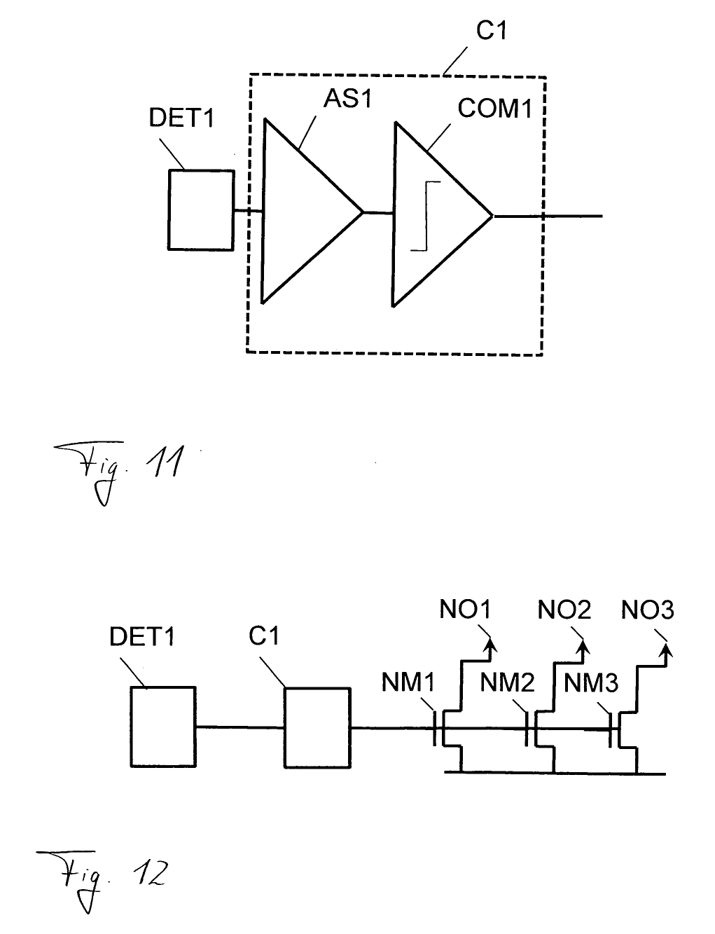

FIG. 13 illustrates a further embodiment of a readout circuit according to the present invention, in which compression is carried out directly on the analog signals;

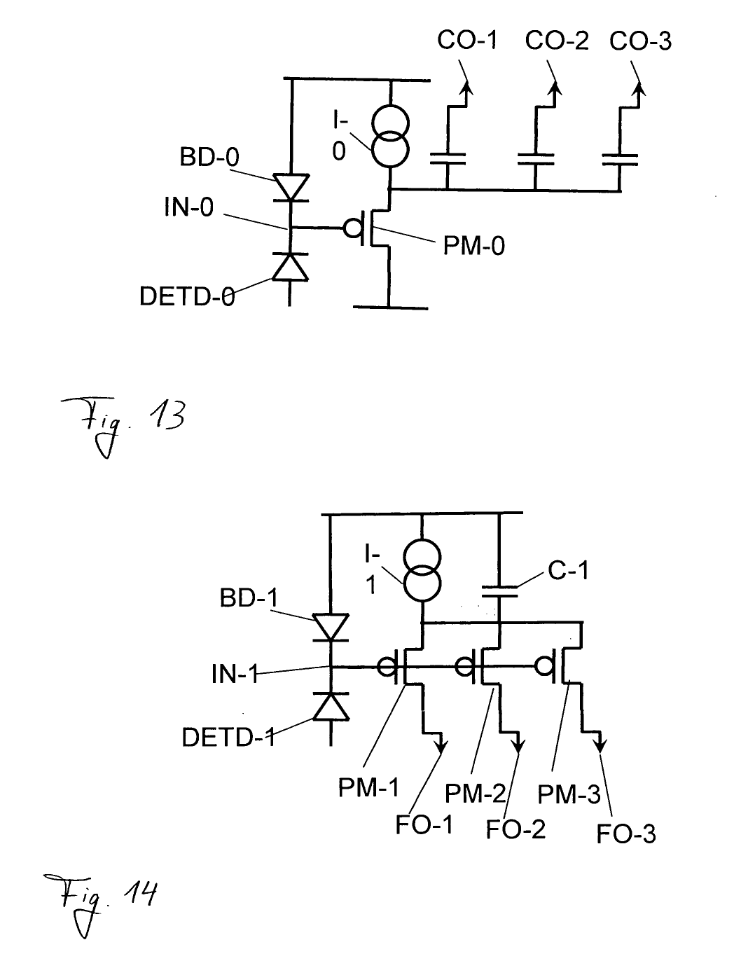

FIG. 14 shows a readout circuit according to another embodiment of the present invention in which compression is carried out directly on the analog signals, but employing a direct galvanic connection;

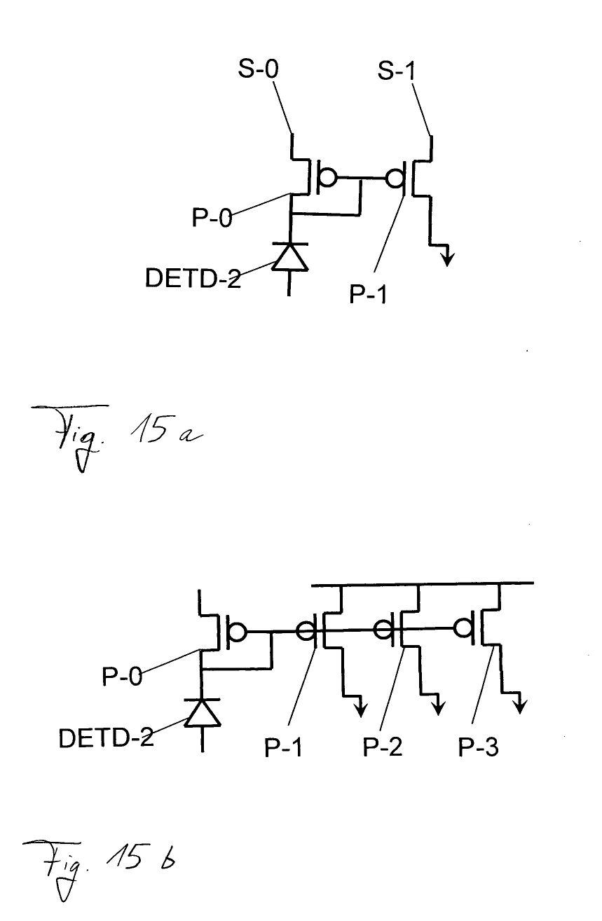

FIG. 15a shows a frontend readout circuit according to an embodiment of the present invention, in which the current signal generated in a detecting diode is mirrored and amplified;

FIG. 15b shows an enhancement of the frontend readout circuit according to FIG. 14a, in which the current signal collected from a sensitive element is mirrored to three readout channels;

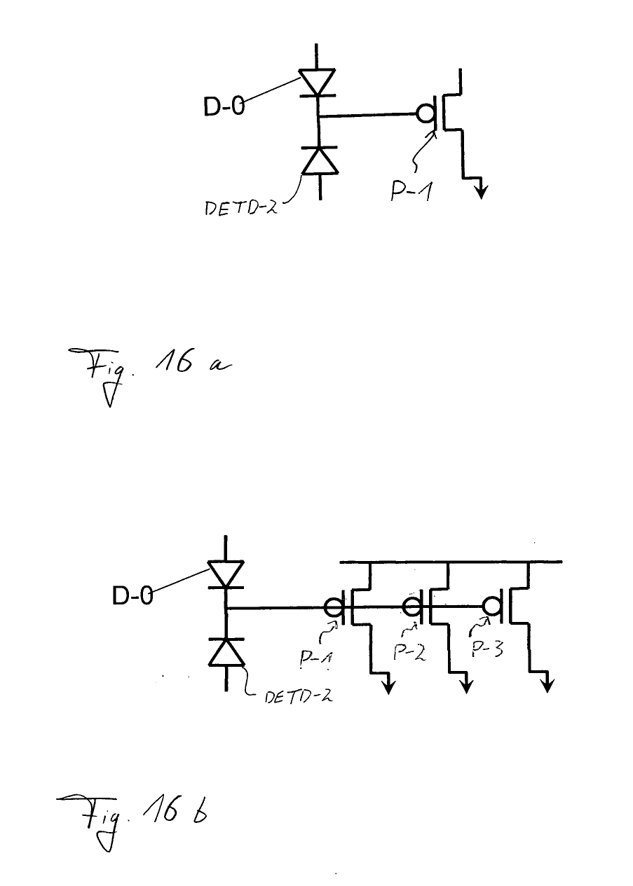

FIG. 16a shows an alternative frontend readout circuit according to an embodiment of the present invention;

FIG. 16b shows an enhancement of the frontend readout circuit shown in FIG. 15a, in which the current signal from a sensitive element is mirrored to three readout channels;

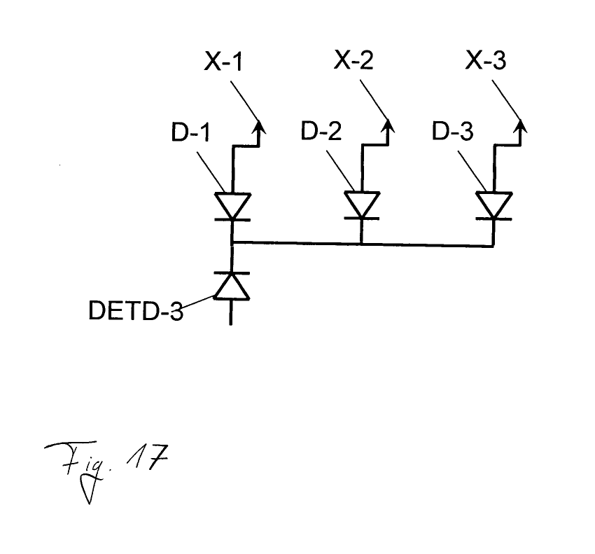

FIG. 17 shows an example of how the current of a detecting element can be divided over different outputs by a number of circuit elements; and

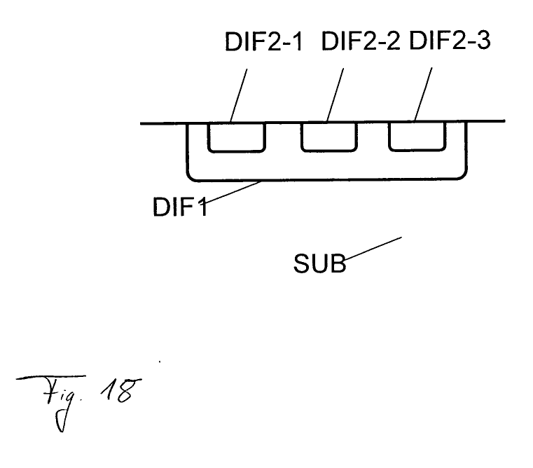

FIG. 18 shows an example of how the current of a detecting diode as an example of a detecting element, formed by a first diffusion into a substrate, can be divided over different outputs by creating a second set of diodes formed by a set of second diffusions into the first diffusion.

The invention will now be described with reference to the specific example of a two-dimensional pixel detector as commonly used to generate images from X-rays or ionizing particles. However, the invention is not so limited and may be employed on any sparsely populated data array.

The invention has applications in all the fields where detectors of this type are currently in use, ranging from medical applications and material imaging to electron microscopy as well as laser beam/light beam position sensing.

For simplicity, the discussion of the preferred embodiments will assume an input data set of N² elements. While the physical arrangement of such elements is not relevant, in the figures as well as in the description they will be represented as square N by N array, as schematically depicted in FIGS. 1 to 3. However, the invention is not limited to these specific examples, but may be applied to any array of detector elements in any particular shape. It should also be emphasized that the sensitive elements, such as pixels, may not be of a rectangular or square shape, but may be provided in any shape.

### (i) Data Compression by Static Mapping

Compression according to the present invention may be described in terms of static data mapping, i.e. by mapping a set of input values to a set of output values using static maps, where “static” means that those maps do not change with respect to the time-scale of the input signal.

FIG. 7 illustrates a possible four-dimensional mapping in a two-hits scenario. FIG. 7a shows two maps actually identical to the canonical x and y projections. As previously described with reference to FIG. 2a, the canonical projection onto the horizontal and vertical axes fails to distinguish between a two-hit scenario (with dark-shaded hits) and a four-hit scenario (with additional light-shaded hits). FIG. 7b shows the same pair of hits in the same pixel matrix, but mapped through a different pair of maps (u,v). The output values of the u map correspond to the nine numbers inside each cell of the sub-matrix sketched at the bottom-left of the pixel array. This coordinate pattern is repeated for each of the further eight sub-matrices. The v map outcome labels the sub-matrix. As can be taken from FIGS. 7a and 7b, the real hits match the intersection between the (x, y) pair and the (u,v) pair, whereas the aliases do not match. Hence, introducing an additional set of maps help to resolve these ambiguities.

This example uses four maps and provides a rather effective method to reject aliases. For the same compression ratio, the inventors found that it is possible to define a class of sets of four maps providing the best possible performance in rejecting aliases. This can be further generalized for a set of an arbitrary number of maps. The following discussion will illustrate this general approach.

Assume a set of P input elements in n dimensions, and that it is possible to have at least n+1 different maps π_{d}, π_{d}: P->O_{d}, π_{d}(pᵢ)=o_{d,j}, 1≦d≦n+1, pᵢ being any element of the input data set P, 1≦i≦|P|, and o_{d,j} being any element of the output data set O_{d} defined by the map π_{d}, 1≦j≦|O_{d}|. The situation is sketched in FIG. 4a. We use here the notation |X| to indicate the number of elements (the cardinality) of a set X, and in the same fashion we use |π(X)| do denote the cardinality of the image of X by the map π. The compression ratio will be hence equal to

$$r = \frac{\vert P \vert}{{\sum }_{d = 1}^{n + 1} \vert {O}_{d} \vert} \qquad ( a )$$

We now define the subset S_{d,j} as the subset containing all the elements of P which the map π_{d} maps into the output element o_{d,j}, 1≦j≦|O_{d}|: S_{d,j}={pᵢεP|π_{d}(pᵢ)=o_{d,j}}. Under the condition that π_{d} does not associate more than one output to any input element, the union of all S_{d} for a given π_{d} forms a partition of P, as shown in FIG. 4b: ∪_{d,j}S_{d,j}=P. The inventors found that the following condition effectively ensures that the map provides a uniform coverage over the input data elements, i.e. that by choosing a random element from the input set there is the same probability it will be mapped into any of the map outputs:

|S_{d,j}|=cost. for every o_{d,j}, 1≦j≦|O_{d}|. (b)

After establishing uniformity, a second aspect is to “maximize” the ability to reject aliases. Aliases may be generated by spurious intersections of the input subset S_{d,j}, i.e. intersections of subsets defined by output elements not generated by the same input element. To minimize the chance that this happens, the number of potential intersections between such subsets should be minimized a priori. The inventors found that this may be achieved if the following condition holds for every possible pair of maps π_{d}, πₑ, 1≦d,e≦n+1, e≠d:

|πₑ(S_{d,j})|=|S_{d,j}| (c)

This condition establishes “local orthogonality”: as illustrated in FIG. 4c, every map maps any input subset defined by any other map into a number of output elements equal to the number of input elements contained into the subset. In a preferred embodiment, each map has an output data set of the same size of the other maps:

|πₑ(S_{d,j})|=|S_{d,j}|=|πₑ(P)|=cost. (d)

In this case, the size of the image of P through every map is constant, the same for all the maps, and the image of any map, except the one which defines it, applied to the subset S_{d,j} is as well equal to that constant. This condition translates into the fact that any pair of maps actually provides a complete Cartesian decomposition of the P data set. In the special case where |P|=N², relation (d) is actually equivalent to:

|πₑ(S_{d,j})|=|πₑ(P)|=N, 1≦d,e≦n+1, e≠d, 1≦j≦N, (e)

stating that all the maps have an image of the same size, that size being equal to N, the square root of |P|.

In the following the inventors provide two explicit examples where the previous conditions are applied.

### (ii) Three Maps Implementation

The inventors found that the ambiguities associated with multiple hits can be reduced efficiently by using three maps. Assuming an input set composed by N² elements, and calling i the running index identifying each input element, 1≦i≦N², the three maps may be described by the following relations:

πₓ(i)=i mod N

π_{y}(i)=└i/N┘

π_{w}(i)=(i+k└i/kN┘)mod kN

where └a┘ denotes the largest integer no larger than a. The πₓ and π_{y} maps can be actually thought as the canonical projections if we imagine to (topologically) rearrange the original data set in an N by N matrix. The first two maps have an image size of P equal to N, while the third one has an image size of P equal to kN. All three maps also provide a complete partition of P.

The inventors found that this selection of maps satisfies the local orthogonality.

In that case the compression ratio is equal to:

$$r = \frac{{N}^{2}}{2 N + kN} = \frac{N}{2 + k} .$$

An example of a set of maps satisfying these constraints is illustrated in FIG. 5a for a square array 10 of 8×8 pixel elements 12. The maps πₓ and π_{y} coincide with the canonical x and y projection as naturally derives from the square symmetry in which the elements have been arranged. The map π_{w} has a range of size eight, with the eight corresponding collection bins 20 distinguished in FIG. 5a by different symbols. The sensitive elements in the matrix are designated with corresponding symbols, wherein signals from pixels that share a common symbol are each collected in the corresponding readout bin 20. As can be taken from FIG. 5a, signals for one of the readout bins (indicated by a black circle) are collected from the main diagonal. The remaining readout bins collect signals from two shorter diagonals each, which are chosen such that they extend in parallel to the main diagonal and their total number of elements equals N=8.

The projective map illustrated in FIG. 5a satisfies conditions (a), (b) and (c), and is well-suited for an implementation in hardware in which sensitive elements associated with a collection bin are directly linked by an electrical connection, such as a readout channel.

The corresponding readout circuitry is shown in FIG. 5b. For ease of presentation, only a fraction of the readout channels are illustrated in FIG. 5b. Readout channels 22a, 22b extending along the columns of the array collect signals in the first plurality of readout bins 24 labeled by the x-coordinate of the sensitive elements. Readout channels 26a, 26b collect signals along the rows of the array in a second plurality of readout bins 28 labeled by the x-coordinate. Two of the readout channels 30a, 30b for the additional diagonal projection π_{w} are likewise shown in FIG. 5b. Signals from these channels 30a, 30b are collected in readout bins 32 labeled with coordinate w. Since the sensitive elements associated with the common readout bin are arranged along diagonals of the array, the corresponding readout channels 14a, 14b may follow the same diagonals, and hence are relatively simple to implement.

Even though not all of the readout channels are shown in FIG. 5b, it is understood that each of the sensitive elements of the readout array is connected to three different readout channels, one for the vertical projection, πₓ, one for the horizontal projection π_{y}, and one for the diagonal projection π_{w}.

Two implementations of the projection map π_{w} for a square array of 9×9 pixel elements are illustrated in FIGS. 6a and 6b, respectively. Signals are conventionally projected both along the horizontal and vertical directions, but are in addition collected according to the compression map π_{w}. The number given to each cell in the array corresponds to the value of the respective coordinate w under the mapping π_{w}, and hence to the corresponding readout bin. FIG. 6a illustrates the case for k=1, whereas FIG. 6b corresponds to k=3. For ease of illustration, the sensitive elements corresponding to w=3 in FIG. 6a and to w=12 and w=23 in FIG. 6b are highlighted. In both cases, the capability of resolving ambiguities is increased compared to the conventional methods described with reference to FIGS. 1, 2, and 3.

(iii) Implementation Using Four Balanced Maps

The inventors found that an implementation based on four balanced maps provides a considerable improvement of the ability to reject aliases, thus increasing reconstruction efficiency. In this implementation a “strong” version of the local orthogonality condition is used, hence the adjective balanced.

Assuming the input set composed by N² elements, and calling i the running index identifying each input element, 1≦i≦N², the four maps (πₓ, π_{y}, πᵤ, πᵥ) are described by the following relations:

πₓ(i)=i mod N

π_{y}(i)=└i/N┘

πᵤ(i)=(i+└i/N┘)mod N

πᵥ(i)=(i+└i/N┘(N−1))mod N

where └a┘ denotes the largest integer no larger than a. The πₓ and π_{y} maps can be actually thought as the canonical projections if we imagine to (topologically) rearrange the original data set in an N by N matrix. Preferably, N is an odd number.

In that case the compression ratio is equal to:

$$r = \frac{{N}^{2}}{4 N} = \frac{N}{4}$$

FIGS. 8a and 8b illustrate one possible set of maps according to these conditions. Projections for the first set of coordinates (x,y) proceed along the columns and rows, respectively. The number pairs inside each cell of the array represent the values of the u-coordinate (top, in italics) and the v-coordinate (bottom, bold face), respectively. Shaded areas in FIGS. 8a and 8b help to visualize the local orthogonality condition. In FIG. 8a the shaded area contains all the cells where u=1, while in FIG. 8b the shaded area encompasses all the cells satisfying v=2. The local orthogonality requirement corresponds to the fact that by staying inside the shaded area, every other value of every other coordinate is hit (surjectivity) and is hit only once (injectivity).

A graphical representation of a mapping as described above is illustrated in FIGS. 9a and 9b, respectively. Similarly to FIGS. 8a and 8b, the number pairs inside each cell correspond to the values of the u-coordinate (top, italics) and the v-coordinate (bottom, bold face), respectively. The shaded areas are again a visualization of the local orthogonality condition. In FIG. 9a, the shaded area comprises all the pixel cells for which u=2. In FIG. 9b, the shaded areas comprise all the pixel cells for which y=2, whereas cells satisfying v=2 are indicated with dashed lines.

In the embodiment illustrated in FIGS. 9a and 9b, cells with equal u-coordinate are arranged along the diagonals from the top left to the bottom right corner, whereas cells with equal v-coordinate are likewise arranged along diagonals, but running from the bottom left to the top right corner of the square array. This configuration is particularly suitable for a direct implementation in hardware. Readout channels for projective readout along the u-coordinates and v-coordinates extend along the same diagonals, and hence do not require any involved wiring.

The reconstruction performance achieved with column and row projections x and y and additional projections u and v is illustrated in FIG. 10. The graph shows the percentage of correctly reconstructed hits (“purity”) as a function of the number of hits per frame, for square arrays of different sizes N=512, N=1024 and N=2048. As can be taken from the graph, ambiguities can be effectively resolved if the number of hits per frame is not too large.

All the previous embodiments employed one or two additional projective maps on a two-dimensional matrix. This approach can be generalized to more additional projective maps on a two-dimensional matrix. Moreover, the invention is not limited to a two-dimensional matrix: a linear or one-dimensional detector configuration could be mapped into two dimensions first, and could then be read out with the projective compression scheme as described above. In one embodiment a linear array of elements of length N² could be mapped into a two-dimensional N by N matrix. More generally, one can map the original set of elements into a certain number of dimensions and introduce the corresponding number of projective mappings, for instance the canonical ones, and an additional number of projective maps which satisfy constraints as in the previous embodiments. One may also deviate from the full local orthogonality requirement, and relax this constraint. This may lead to some degeneration in ambiguity resolving capability, but might allow a simpler practical implementation. As an example, if the probability of receiving a hit is not uniform across the set of elements, one might consider tuning the mapping to maximize the ambiguity resolving capability in the areas of higher occupancy by sacrificing local orthogonality in the other areas.

### (iv) Frontend Readout Circuits

Advantageously, the projective mappings according to the present invention may be directly implemented in hardware. This allows the compression to be performed as early as possible in the readout chain. The number of signals to be treated for subsequent analysis and storage can hence be reduced, entailing power and space savings.

One way to implement the projective mappings in hardware is to combine the outputs of sensitive elements by implementing a wiring scheme corresponding to the maps in the compression method. Each output line corresponds to the output data element of one map, and one output of all sensitive elements mapped by this map in that output data element should be connected to this output line.

In the following several embodiments of the readout circuitry will be described for the example of one additional projective map for compression in a two-dimensional detector array. All these embodiments will therefore be shown with three pixel outputs, each of which to be connected to one of the three output lines corresponding to that pixel. For these examples, data is compressed from N² to 3N, a significant compression for large values of N. For instance, if N=1000 this represents a compression of about 300. It is to be understood that the number of outputs can be increased to implement embodiments of the compression scheme with a larger number of projective mappings.

FIG. 11 shows a prior art circuit C1 comprising an amplifier shaper circuit AS1 and a comparator COM1. This circuit C1 is connected to a detecting element DET1 and will drive the output of the comparator COM1 to a logic 1 if the signal received on the detecting element is above a certain threshold.

In a preferred embodiment, the invention can be implemented using the digital output to act on the output lines corresponding to the projective maps used in the compression. An example is shown in FIG. 12, where the circuit C1 as described with reference to FIG. 11 is complemented by three NMOS transistors NM1 . . . 3 with respective drains NO1 . . . 3. If the detecting element DET1 receives a signal above threshold, the comparator output will be driven high and will switch the transistors NM1 . . . 3 on. These transistors will then pull current out of the line to which their drain is connected. This current can be detected by a current comparator circuit. All the transistors linked to one output line are in parallel. This is similar to a “wired or”, where one needs to make the logic “or” of all the inputs. There are many alternative circuit solutions for implementing a “wired or”, and all these solutions can be applied in the context of the present invention.

According to an embodiment of the invention, the compression can be implemented using the analog output of the frontend to act on the output lines corresponding to the projective maps. An example is shown in FIG. 13. The detecting element is a diode DETD-0 which can be reverse biased and whose leakage current is provided by another diode BD-0, which is therefore slightly forward biased. The node to which both diodes DETD-0 and BD-0 are connected is the input node IN-0. If the diode DETD-0 receives some signal charge from the sensitive element, this charge will be collected in the input node IN-0, and will cause the electrostatic potential of IN-0 to change. This change may be detected by a source follower comprising a PMOS transistor PM-0 and a current source I-0 to bias PM-0. The source follower is connected with its input, the gate of PM-0 to IN-0. Due to the follower action, the source of PM-0, the output of the source follower, will almost fully follow any change in electrostatic potential at the gate of PM-0. Three output capacitors a CO-1 . . . 3 are connected in parallel to this follower output, each corresponding to one projective map employed in the compression.

If the diode DETD-0 collects some signal charge, a corresponding charge is injected in each of the output lines to which an output capacitor CO-1 . . . 3 is connected. This injected charge can be detected by means of a conventional charge detection circuit. If the follower and the charge collection in the diode DETD-0 are sufficiently fast, one may also detect the current injected to the output lines rather than the charge.

FIG. 14 illustrates a further embodiment wherein a compression is implemented using the analog output of the frontends. The detecting element is again a diode DETD-1, which can be reverse biased and whose leakage current is provided by another diode

BD-1, which is therefore slightly forward biased. The node to which both diodes are connected is the input node IN-0, which is the node on which any signal charge generated in DETD-1 is collected. Three PMOS transistors PM-1 . . . 3 are connected to this input node via their respective gates. The sources of the PMOS transistors PM-1 . . . 3 are linked and are also connected to a current source I-1 and a capacitor C-1. The current source I-1 biases the transistors PM-1 . . . 3, which operate like a source follower. However, the capacitive load C-1 has to be charged when a charge signal is collected onto IN-1, and this may cause a transient in the drain current of the three transistors PM-1 . . . 3. The drain of each of these three transistors is connected to one of the output lines corresponding to the projective maps of the compression for this detecting diode DETD-1. This current transient can again be detected using a current comparator.

For a detecting element generating a current signal when hit, in a preferred embodiment this current is amplified in multiple copies and sent (one copy per output line) over the appropriate output lines. The amplification may or may not include additional filtering.

In an aspect of the invention, this current may be amplified by a readout circuit comprising an impedance element which receives the current delivered by the detecting element on one terminal, transferring said current to a fixed voltage connected to its second terminal, wherein the current through this impedance element causes a potential difference to be developed across this impedance element, and wherein this potential difference is used to drive one or more current outputs. FIG. 15a and FIG. 16a each show specific examples of such a readout circuit, especially suited for detecting elements with low parasitic capacitance.

The frontend circuit in FIG. 15a has some similarity with a well-known current mirror circuit, but is modified to overcome some limitations. The detecting element is a diode DETD-2 which can be reverse biased. The leakage current of DETD-2 is absorbed by a diode-connected transistor P-0. The source of P-0 is connected to a bias S-0. The gate of the transistor S-0 is connected to the gate of a second transistor P-1, connected with its source to a bias S-1, which may or may not be identical to S-0. If S-1 and S-0 are identical, P-0 and P-1 form a current mirror circuit, where the current in P-0 is mirrored to P-1 with a ratio determined by the respective ratios of width W and length L of P-0 and P-1. If the detecting element DETD-2 receives a hit from an ionizing particle, it will generate a current which will be absorbed by P-0 and mirrored to P-1 with the ratio as describe above. The output current is made available at the drain of P-1. Current gain can be achieved by choosing the width W and length L of P-0 and P-1 appropriately, but this may lead to excessive parasitic capacitance. Another way of influencing the current gain is to choose different source biases S-0 and S-1. This is usually not done in current mirrors, but the inventors found that it can help to reduce transistor sizes and hence parasitic capacitance, and also allows to tune the gain after design and fabrication. In some cases it may be advantageous to link the Nwell biases of P-0 and P-1 to their gate to also act on the body contact of the transistors.

FIG. 16a shows a modification of the embodiment of FIG. 14a where the diode-connected transistor P-0 is replaced by a diode D-0. The circuit operates in a similar way: the signal current collected by the DETD-2 is amplified and made available at the drain of the transistor P-1.

Since the mechanism in the inventive frontend is similar to the one used in the current mirror, where a current is amplified and made available at the drain of a second transistor by steering the gate of the second transistor using the first transistor, one can add more transistors steered in the same way and hence implement a larger number of outputs. The compression according to the invention can then be implemented by connecting each of the outputs to one of the output lines corresponding to the projective maps of the compression for the detecting diode DETD-2. FIGS. 15b and 16b illustrate such multi-output enhancements of the single-output frontends shown in FIGS. 15a and 16a, respectively. The signal current collected by DETD-2 is mirrored to P-1 . . . 3 which inject current into the output lines, which then again can be detected or processed by a current comparator or another current processing circuit. One may introduce a desired level of amplification by varying the ratio of the dimensions of P-0 to P-1 . . . 3. One may further change the bias of the source of P-1 . . . 3 compared to the source of P-0 to obtain additional current amplification. One may also—in case the technology allows it—connect the body of the transistors to the gate. The current in the output lines can be processed using standard techniques. As an example, a current comparator could detect a peak in the current corresponding to a hit in the detecting element. Another example is to apply the current to an analog-to-digital converter.

In a further aspect, the invention relates to a readout circuit for an imaging detector comprising a detecting element which is connected with one of its terminals to a plurality of circuit elements, said plurality of elements dividing the current from the detecting element over several outputs.

This configuration likewise allows transferring a readout signal collected from the detecting element to a plurality of readout channels, but by dividing the signal rather than amplifying it, and allows the implementation of the compression of the invention, provided the signals generated by the detecting elements are sufficiently large.

An embodiment of such readout circuit for a detecting element DETD-3 is shown in FIG. 17. DETD-3 delivers a current signal to a collection electrode which is connected to three diodes D-1 . . . D-3. Each of the diodes D-1 . . . D-3 is connected by their other terminal X-1 . . . X-3 to one of the output lines, which according to the compression scheme correspond to the detecting element DETD-3. The signals generated by the detecting elements hence directly drive the corresponding output lines. This configuration places the readout circuitry entirely after the compression in the chain, and therefore offers a maximum gain in space. Whether a similar gain in power consumption can be reached depends on the amplitude of the input signals. If too much power has to be consumed to recover the signal on the output lines, one may prefer to first amplify and possibly filter the signals generated by the detecting elements prior to applying them to the output lines corresponding to their projective maps.

Preferably, the number of diodes coupled to said detecting element equals three or four, corresponding to three or four readout channels connected to a given sensitive element of the imaging detector.

In the embodiment illustrated in FIG. 18, the detecting element DETD-3 is a diode itself. The detecting element DETD-3 may be manufactured by a first diffusion or implant DIF1 into a substrate SUB, said first diffusion or implant being of the type opposite to the type of the substrate, and wherein said plurality of diodes D-1 . . . D-3 is created by a plurality of second diffusions or implants DIF2-1 . . . DIF-3 into said first diffusion or implant, said plurality of second diffusions or implants being of the same type as the substrate. As an example the substrate SUB can be p-type, the first diffusion DIF1 n-type, and the plurality of second diffusions DIF2-1 . . . DIF2-3 p-type. The reverse charge types may likewise be employed.

A further step is to split the original detecting element, and divide the signal over different outputs. An example of this was proposed for the diagonal projection by Z. Li et al, but this principle can also be applied here. It is a further aspect of the invention that the compression method of the invention also can be applied in this case, where different detecting elements are used for the different maps.

The specific embodiments and the accompanying drawings merely serve to illustrate the invention and the beneficial effects associated therewith, but should not be understood to imply any limitation. The scope of the invention is determined solely by the appended claims.

1-39. (canceled)

40. A method for compressing a data array P of data elements, said data array P being arranged in n dimensions for some positive integer n, said method comprising the steps of:
defining a plurality of at least n+1 compression maps π_{d} on said data array P, 1≦d≦n+1; and
associating with each range value o_{d,j} of π_{d} a compression fiber S_{d,j}={pεP|π_{d}(p)=O_{d,j}};
such that said compression fibers S_{d,j} for each compression map π_{d} are of at least approximately constant size among all said range values j, |S_{d,j}|=c_{d} for all j, for some constant c_{d}, where |•| denotes the set cardinality.

41. The method according to claim 40, wherein said compression fibers S_{d,j} are of at least approximately constant size among all said range values j and maps π_{d}, |S_{d,j}|=c for all j,d, for some constant c.

42. The method according to claim 40, wherein |πₑ(S_{d,j})|≧|S_{d,j}| holds for almost all compression fibers S_{d,j} and for all pairings of compression maps πₑ, π_{d} such that πₑ≠π_{d}, d,e=1, . . . , n+1.

43. The method according to claim 40, wherein the fiber S_{d,j} is mapped into the entire range of the compression map πₑ for almost all compression fibers S_{d,j} and for all pairings of compression maps πₑ, π_{d} such that πₑ≠π_{d}, d,e=1, . . . , n+1.

44. The method according to claim 40, wherein the number of compression fibers S_{d,j} is approximately constant for all compression maps π_{d}.

45. The method according to claim 40, wherein |πₑ(S_{d,j})|=|πₑ(P)| holds for almost all compression fibers S_{d,j} and for all pairings of compression maps πₑ, π_{d} such that πₑ≠π_{d}, d,e=1, . . . , n+1.

46. The method according to claim 40, wherein n=2 and the method comprises the step of defining three compression maps.

47. The method according to claim 46, wherein said data array P is representable as a square array with N by N elements, and π₃ has an range cardinality that divides N.

48. The method according to claim 46, wherein said data array P comprises N² data elements representable by an index i, i=1, . . . , N², and
π₁(i)=i mod N,
π₂(i)=└i/N┘, and
π₃(i)=(i+k└i/(kN)┘)mod kN,
wherein, for any real number a, └a┘ denotes the largest integer no larger than a and |π₃(P)|=k×N.

49. The method according to any of the claim 40, wherein n=2 and the method comprises the step of defining four compression maps.

50. The method according to claim 49, wherein said data array P comprises N² data elements representable by an index i, i=1, . . . , N², and
π₁(i)=i mod N,
π₂(i)=└i/N┘,
π₃(i)=(i+└i/N┘)mod N, and
π₄(i)=(i+└i/N┘(N+1))mod N,
wherein, for any real number a, └a┘ denotes the largest integer no larger than a.

51. A readout circuit for a data array of data elements, said readout circuit comprising:
an impedance element, said impedance element having a first terminal adapted for connection to a data element, said impedance element further having a second terminal for connection to a first bias voltage source; and
a first transistor element having a first terminal coupled to said impedance element and a second terminal for connection to a second bias voltage source, wherein said second bias voltage is different from said first bias voltage.

52. The readout circuit according to claim 51, wherein said first terminal of said first transistor element is a gate terminal, and/or said second terminal of said first transistor element is a source terminal.

53. The readout circuit according to claim 51, comprising at least one further transistor element, wherein each said further transistor element has a respective first terminal coupled to said impedance element and to said first transistor element, and wherein each said further transistor element has a respective second terminal for connection to said second bias voltage source.

54. The readout circuit according to claim 53, wherein said first transistor element and said further transistor elements each have a third terminal for connection to a respective readout channel.

55. The readout circuit according to claim 51, wherein said impedance element comprises a transistor, in particular a transistor having a source terminal for connection to said first bias voltage and a gate terminal and/or drain terminal for connection to said data element.

56. The readout circuit according to claim 55, wherein said impedance element comprises a diode.

57. A readout circuit for a data array of data elements, said readout circuit comprising a plurality of identical circuit elements associated with a common data element, wherein each of said plurality of circuit elements is adapted to be coupled to a corresponding readout channel.

58. The readout circuit according to claim 57, wherein said circuit elements are adapted to be coupled to said common data element.

59. The readout circuit according to claim 57, wherein said circuit elements comprise diodes formed by providing a respective plurality of diffusions and/or implants in a common substrate.
